(19) United States
(12) Patent Application Publication
(10) Pub. No.: US 2016/0045392 A1
(43) Pub. Date: Feb. 18, 2016

(54) METHODS AND DEVICES FOR FLEXURAL ADULT DEVICES

(71) Applicant: Matthew Douglas MASSEY, Carleton Place (CA)

(72) Inventors: Matthew Douglas MASSEY, Carleton Place (CA); Gary Chi-Wai LEE, Kanata (CA)

(21) Appl. No.: 14/773,622

(22) PCT Filed: Feb. 26, 2014
(86) PCT No.: PCT/CA2014/000142

§ 371 Date: Sep. 8, 2015

Related U.S. Application Data
(60) Provisional application No. 61/769,425, filed on Feb. 26, 2013.

(51) Int. Cl. A61H 19/00; A61H 23/00; A61H 1/00

(52) U.S. Cl. CPC A61H 19/00; A61H 1/008; A61H 23/00; A61H 2205/087

(57) ABSTRACT

When comparing the mechanical engagement means of prior art sex toys it is evident that with the exception of the very limited work on hydraulic and linear motion actuators that there are no solutions targeting the requirements of providing an alternative drive means to stimulate in the same manner as do human fingers and thumbs. Beneficially a drive mechanism to achieve this should allow for low and very low frequency operation either discretely or in combination with higher frequency vibratory motions whilst providing high amplitude stimulation. Further, it would be beneficial for the motion to be at least directed in one direction with high amplitude, e.g. side to side on the clitoris or nipple or applying pressure such on the G-spot or prostate. Further it would be beneficial for motion to be at least directed in two axes such as circular motion on a user's, or their partner's, nipple, clitoris, testes, or penis as well as applying pressure and motion simultaneously to the G-spot or prostate for example. Such high amplitude motion based devices would beneficially provide for both sexual stimulation of one or more regions of a male user, female user, same sex couple, or different sex couple during sexual stimulation, foreplay and sexual activities.

### CROSS-REFERENCE TO RELATED APPLICATIONS

This application claims the benefit of priority from U.S. Provisional Patent Application Ser. No. 61/769,425 filed Feb. 26, 2013 entitled “Methods and Devices for Flexural Adult Devices.”

### FIELD OF THE INVENTION

The present invention relates to devices for sexual pleasure and more particularly to devices exploiting flexural motion in conjunction with wiper, slider, vibratory and non-vibratory excitation.

### BACKGROUND OF THE INVENTION

Sex toys are objects or devices that are primarily used to facilitate human sexual pleasure and typically to date have been designed to resemble human genitals, albeit perhaps in an abstracted form at times, and may be vibrating or non-vibrating. Throughout history there have been a plethora of devices used and/or sold for sexual pleasure, although primarily under euphemistic names and a pretense of providing “massage” before the 1960s. Their history extends back through ancient Greece to the Upper Palaeolithic period before 30,000BC. Modern devices fall broadly into two classes, mechanized and non-mechanized, and essentially can be traced back to 1902 when the American company Hamilton Beach patented the first electric vibrator available for retail sale, thereby making the vibrator the fifth domestic appliance to be electrified.

Mechanized devices typically vibrate, although there are examples that rotate, thrust, and even circulate small beads within an elastomeric shell. Non-mechanized devices are typically made from a solid mass of rigid or semi-rigid material in a variety of shapes. Examples of prior art non-mechanized devices which require their motion to be induced either by the individual user themselves or a partner within the prior art include U.S. Pat. Nos. 5,127,396; 5,853,362; 5,690,603; 5,690,604; 5,853,362; 6,436,029; 6,599,236; 6,533,718; 6,997,888; 7,513,868; 7,530,944 as well as U.S. Patent Applications 2003/0,023,139; 2005/0,228,218; 2007/0,106,109; 2010/0,087,703; 2010/0,204,542; 2010/0,087,703; 2011/0,082,333; 2011/0,021,870; 2011/0,124,959; 2012/0,123,199; 2012/0,136,205 and 2012/0,143,001. Other associated prior art relates to how such devices may be “worn” by a partner either with or without the need of straps or belts or used by an individual and includes U.S. Pat. Nos. 5,725,473; 6,203,491; and 6,991,599 as well as U.S. Patent Applications 2010/0,087,703; 2011/0,082,333; and 2012/0,118,296.

Not surprisingly many early mechanized devices within the prior art were primarily intended to automate the motion of penetrative intercourse or masturbation and accordingly tended to be based upon large frames. Such prior art includes for example U.S. Pat. Nos. 4,722,327; 4,790,296; 5,076,261; 5,501,650; 5,851,175; 6,142,929; 6,866,645; 6,890,293; 6,899,671; 6,902,525; 7,524,283; 8,313,424 and U.S. Patent Application 2004/0,147,858. There are also within the prior art examples of devices exploiting hydraulic or linear motor drive elements to provide motion of the device even when held rigidly by the user at one end such that a simulation of penetration is achieved. Such prior art includes U.S. Patent Applications 2005/0,049,453; 2005/0,234,292; 2009/0,118,650; 2009/0,275,796; and 2010/0,041,944.

In contrast to these mechanized devices producing repeated penetrative action vibrators are used to excite the nerve endings in the pelvic region, amongst others, of the user such as those same regions of the vagina which respond to touch. For many users the level of stimulation that a vibrator provides is inimitable. They can be used for masturbation or as part of sexual activities with a partner. Vibrators may be used upon the clitoris, inside the vagina, inserted into the rectum, and against nipples either discretely or in some instances in combination through multiple vibratory elements within the same vibrator or through using multiple vibrators.

Vibrators typically operate through the operation of an electric motor wherein a small weight is attached off-axis to the motor resulting in vibration either due to the imbalanced assembly or the weight impacting the body of a portion of the vibrator. Vibrators may coupled to through an electrical mains connection but are more typically battery driven which places emphasis on efficiency to derive not only an effective vibration but one over an extended period of time. Example of such vibrators within the prior art include U.S. Pat. Nos. 3,626,931; 5,573,499; 5,853,362; 6,741,895; 6,749,557; 6,902,525; 7,108,668; 7,166,072; 7,438,681; 7,452,326; 7,604,587; 7,871,386; 7,931,605; 7,967,740; 8,308,631 and U.S. Patent Applications 2002/0,103,415; 2003/0,195,441; 2004/0,082,831; 2005/0,033,112; 2006/0,047,181; 2006/0,074,273; 2006/0,106,327; 2006/0,247,493; 2007/0,055,096; 2007/0,232,967; 2007/0,244,418; 2008/0,009,775; 2008/0,071,138; 2008/0,082,028; 2008/0,119,767; 2008/0,139,980; 2009/0,093,673; 2008/0,228,114; 2009/0,099,413; 2009/0,105,528; 2009/0,318,753; 2009/0,318,755; 2010/0,292,531; 2011/0,009,693; 2011/0,034,837; 2011/0,082,332; 2011/0,105,837; 2011/0,166,415; 2011/0,218,395; 2011/0,319,707; 2012/0,179,077; 2012/0,184,884; and 2012/0,197,072.

It would be evident from consideration of the prior art and devices described above that these devices are primarily driven to stimulation of the female clitoris, vagina and rectum as well as the male rectum. Whilst vibrators such as described supra may be used for stimulating the male penis there has been relatively little prior art and development towards stimulating the male penis through simulation of intercourse above and beyond manual devices. Despite, this there are a wide range of vibrators offered commercially to users which fall into several broad categories including clitoral, dildo-shaped, rabbit, G-spot, egg, anal, cock ring, finger ring, bullet, and butterfly but all exploiting the same basic mechanical action of mechanical vibration. Although most vibrators can be used as clitoral vibrators many of the broad categories are designed specifically as clitoral vibrators including rabbit, clitoral, egg, cock ring, bullet and butterfly. Dildo shaped vibrators may be smooth or contoured and offered in a variety of lengths, thickness, and colours ranging from natural to bright pinks, purples, greens, blues etc. In some instances, such as the We-Vibe™, the clitoral vibrator forms part of a vibrator wherein another section is designed to contact the “G-spot.”

In addition to the above general categories there are combinations, including, but not limited to, double ended vibrators for simultaneous use by two users, dual vibrators designed to stimulate two erogenous zones simultaneously or independently (the most common being both clitoral and vaginal), triple vibrators to stimulate three erogenous zones simultaneously or independently (e.g. anal, clitoral, and vaginal) within a single body. Typically, all vibrators, with the exception of bullet vibrators, are multispeed wherein an integral controller or one remote via cable or wireless interface allows the user(s) or partner(s) to adjust how fast the vibrator vibrates from a small number of pre-programmed options. A much more niche category is electrostimulators which are designed to apply electrical stimulation to the nerves of the body, with particular emphasis on the genitals, in combination with a dildo or vibrator element.

However, off-axis weight based motors cannot easily operate at low frequencies nor do they induce excitation to the user in a manner that mimics the interactions and frequencies typical of stimulation through physical intercourse, oral stimulation, or manual stimulation for example. Typically human driven stimulation, even where hurried or frenetic tends to be characterized by very low or low frequency actions with high or very high amplitude. Further, the motion or motions are typically varied in direction and are not effectively fixed position periodic impact as provided by a vibrator. Such low frequency, high amplitude vibrations are desirable to users but are not achieved with the vibrators of the prior art. Oral and manual stimulation varies according to whether it is applied externally, for example to the clitoris or nipple, or internally for example to access the Grafenberg Spot in women, often called the G-Spot or “Female G-Spot”, and the prostate in men, also referred to as the “Male G-Spot”. The female G-spot is an area of the vagina which, when stimulated, can lead to strong sexual arousal, powerful orgasms and even trigger female ejaculation. Similarly, the male G-spot has been associated with increased sexual arousal and stronger male orgasms. The G-Spot is typically described as being located one to three inches (2.5 to 7.6 cm) up the front (anterior) vaginal wall between the vaginal opening and the urethra. Due to the location of the female G-spot, and that of the male prostate, prior vibrators to stimulate these areas are typically characterized by either having a tip that is angled away from the primary axis of the remainder of the vibrator body or by being principally curved in shape. Accordingly, in essence they mimic the stimulation arising from penetrative intercourse by virtue of being, as depicted in FIG. 1 described below, direct or abstract representations of a rigid member inserted into the vagina or anus.

However, “fingering” is a very common aspect of sexual activities. Fingering is the manual stimulation of the clitoris, vulva, vagina, or anus for sexual arousal and sexual stimulation. This may constitute an entire solo sexual encounter, be part of mutual masturbation, foreplay or other sexual activities. For the female fingering outside of the vagina relates to massaging of the vulva, and in particular the clitoris, and is the most common way for a female to reach and achieve an orgasm, see for example Kammerer-Doak et al in “Female Sexual Function and Dysfunction” (Obst. and Gyn. Clinics of N. America, Vol. 35, No. 2, pp. 169-183). The clitoral glans or shaft may be massaged, usually through the skin of the clitoral hood, using up-and-down, side-to-side, or circular motions either alone or the rest of the genitals may also be stimulated by fingering.

For the female, fingering inside the vagina is often performed to stimulate the G-Spot. Described as being recognized by its ridges and slightly rougher texture compared to the more cushion-like vaginal cavity walls around it the G-spot may become engorged with blood from initial stimulation leading to increased sensitivity and strength of sensations with continued manipulation. Many women cite the “come hither” approach as a significant catalyst to orgasm which typically involves the middle finger, sometimes additionally the index or ring finger, wherein the individual or their partner make a hand gesture like “come here” with the palm facing upwards against the pubic bone so that the finger(s) apply periodic pressure to the G-spot. However, other women report other manipulations such as lateral motion, continuous pressure, etc discretely or in combination with other manipulations. Parallels are often drawn with the fingering or other manipulation of the male prostate through the anus.

Anal fingering may be pleasurable to an individual because of the large number of nerve endings in the anal area, and because of the added stimulation gained from stretching the anal sphincter muscles while inserting the finger. Some individuals prefer to simply stimulate the outer ring of the anus, while others will follow this by inserting one or more fingers. Fingering may be seen as an act in itself, or as an arousing prelude in preparation for further anal sex. Anal fingering can arouse the receiver, allowing them to relax their anus and prepare them for the insertion of a penis or any other sexual instrument. Anal fingering is also an effective way of stimulating the prostate in males, and thus may bring the receiver to orgasm. Anal fingering can also stimulate the perineal sponge in females.

Accordingly, when comparing these different stimulation techniques the mechanical engagement means of prior art technologies exploited within sex toys it is evident that with the exception of the very limited work on hydraulic and linear motion actuators for mimicking penetrative actions that there are no solutions targeting the requirements of providing an alternative drive means to stimulate in the same manner as fingering achieves. A sex toy drive mechanism to achieve this should allow for low and very low frequency operation either discretely or in combination with higher frequency vibratory motions whilst providing high amplitude stimulation. Further, it would be beneficial for the motion to be at least directed in one direction with high amplitude, e.g. side to side on the clitoris or nipple or applying pressure such on the G-spot or prostate. Further it would be beneficial for motion to be at least directed in two axes such as circular motion on a user's, or their partner's, nipple, clitoris, testes, or penis as well as applying pressure and motion simultaneously to the G-spot or prostate for example. Such high amplitude motion based devices would beneficially provide for both sexual stimulation of one or more regions of a male user, female user, same sex couple, or different sex couple during sexual stimulation, foreplay and sexual activities.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to devices for sexual pleasure and more particularly to devices exploiting flexural motion in conjunction with wiper, slider, vibratory and non-vibratory excitation.

In accordance with an embodiment of the invention there is provided a device for stimulating a user comprising at least a flexural actuator which mimics at least one of a human finger and a human thumb.

In accordance with an embodiment of the invention there is provided a device comprising:
a first motor comprising at least a first shaft;
a second motor comprising at least a second shaft;
a wiper actuator coupled to the first shaft converting motion of the first shaft to a predetermined locus of motion of a predetermined portion of the wiper actuator;
a flexural actuator to which the wiper actuator is mechanically connected, the flexural actuator also coupled to the second shaft converting motion of the second shaft to a flexing of the flexural actuator; wherein
the resulting motions of the wiper actuator and flexural actuator under control of a controller result in executed motions of the predetermined portion of the wiper actuator which cannot be made by a human finger.

In accordance with an embodiment of the invention there is provided a device comprising:
a controller coupled to a motor;
a flexural actuator for converting motion of the motor to flexure of the flexural actuator; and
a receiver operating according to a predetermined standard coupled to the controller for receiving control data from a transmitter for execution by the controller in controlling the motor.

In accordance with an embodiment of the invention there is provided a device for at least one of:
stimulating a clitoris by simulating the motion of at least one of a finger or a thumb;
stimulating a G-spot by simulating the motion of at least one of a finger or a thumb;
stimulating a prostate gland by simulating the motion of at least one of a finger or a thumb;
stimulating simultaneously a clitoris and a G-spot by simulating the motion of two distal parts of a human limb; and
stimulating a clitoris by simulating the motion of a tongue.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts examples of devices according to the prior art;

FIG. 2A depicts a flexural device actuator according to an embodiment of the invention;

FIG. 2B depict flexural device actuators according to embodiments of the invention;

FIG. 3A depicts a flexural actuator according to an embodiment of the invention as depicted in FIG. 2A;

FIG. 3B depicts a device exploiting a flexural actuator according to an embodiment of the invention;

FIG. 4A depict an actuator supporting wiper or slider motion according to an embodiment of the invention;

FIG. 4B depicts actuators supporting wiper or slider motions according to embodiments of the invention;

FIG. 5 depicts a flexural actuator according to an embodiment of the invention;

FIGS. 6A through 6D depict different actuation configurations for a pair of flexural actuators according to an embodiment of the invention as depicted in FIG. 5;

FIGS. 7A through 7D depict different actuation configurations for a pair of flexural actuators according to an embodiment of the invention with vibratory and wiper augmentation;

FIGS. 8A through 8D depict different actuation configurations for a pair of flexural actuators according to an embodiment of the invention with vibratory and wiper augmentation;

FIG. 9 depicts a device with flexural actuator according to an embodiment of the invention as may be used by male and female users;

FIGS. 10A and 10B depict mechanical configurations for a pair of flexural actuators according to embodiments of the invention;

FIGS. 11A and 11B depict mechanical configurations for a pair of flexural actuators according to embodiments of the invention with vibratory augmentation;

FIG. 12 depicts a mechanical configuration for a pair of flexural actuators for according to an embodiment of the invention with vibratory augmentation for a couple;

FIG. 13 depicts flexural actuators according to embodiments of the invention;

FIG. 14 depicts devices with integral flexural actuators according to embodiments of the invention;

FIG. 15 depicts devices with integral flexural actuators according to embodiments of the invention for use by a couple;

FIG. 16 depicts a device with wiper motion according to an embodiment of the invention;

FIG. 17 depicts a device with a vibratory and flexural actuator according to an embodiment of the invention;

FIG. 18 depicts a network configuration supporting communications with a device according to an embodiment of the invention;

FIG. 19 depicts a configuration supporting local communications between a device, a user's PED, and a wireless access point according to an embodiment of the invention;

FIG. 20 depicts a device with dual flexural actuators and split sliding housing according to an embodiment of the invention;

FIG. 21 depicts a device with dual flexural actuators and split sliding housing according to an embodiment of the invention; and

FIG. 22 depicts a device with flexural actuators according to an embodiment of the invention.

### DETAILED DESCRIPTION

The present invention is directed to devices for sexual pleasure and more particularly to devices exploiting flexural motion in conjunction with wiper, slider, vibratory and non-vibratory excitation.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device may be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “personal electronic device” (PED) as used herein and throughout this disclosure, refers to a wireless device used for communications and/or information transfer that requires a battery or other independent form of energy for power. This includes devices, but is not limited to, such as a cellular telephone, smartphone, personal digital assistant (PDA), portable computer, pager, portable multimedia player, remote control, portable gaming console, laptop computer, tablet computer, and an electronic reader. A “fixed electronic device” (FED) as used herein and throughout this disclosure, refers to a device that requires interfacing to a wired form of energy for power. However, the device may access one or more networks using wired and/or wireless interfaces. This includes, but is not limited to, a television, computer, laptop computer, gaming console, kiosk, terminal, and interactive display.

A “server” as used herein, and throughout this disclosure, refers to a physical computer running one or more services as a host to users of other computers, PEDs, FEDs, etc to serve the client needs of these other users. This includes, but is not limited to, a database server, file server, mail server, print server, web server, gaming server, or virtual environment server.

A “vibrator” as used herein, and throughout this disclosure, refers to an electronic sex toy or device intended for use by an individual or user themselves or in conjunction with activities with another individual or user wherein the vibrator provides a high or medium frequency vibratory mechanical function for stimulating nerves or triggering physical sensations. A “dildo” as used herein, and throughout this disclosure, refers to a sex toy intended for use by an individual or user themselves or in conjunction with activities with another individual or user wherein the dildo provides non-vibratory and non-mechanical based function for stimulating nerves or triggering physical sensations through mimicking a penis.

A “device” as used herein, and throughout this disclosure, refers to a sex toy intended for use by an individual or user themselves or in conjunction with activities with another individual or user which may provide one or more functions including, but not limited to, those of an element of an individual's anatomy such as for example penis, fingers, thumb, or tongue as well as other functions including, but not limited to, dildo, vibrator, clamp, or plug. The device may be designed to have these functions in combination with design features that intended to be penetrative or non-penetrative. Such devices may be designed for use with one or more regions of the male and female bodies including but not limited to, the clitoris, vagina, rectum, nipples, breasts, penis, testicles, prostate, and “G-spot.”

A “nubby” or “nubbies” as used herein, and throughout this disclosure, refers to a projection or projections upon the surface of a device intended to provide additional physical interaction. A nubby may be permanently part of the device or it may be replaced to provide additional variation to the device. An “accessory” or “accessories” refer herein, and throughout this disclosure, refers to one or more objects that may be affixed to or otherwise appended to the body of a device in order to enhance and/or adjust the sensation(s) provided. Such accessories may be passive, such as nubbies or a dildo, or active, such as a vibrator.

A “user”” as used herein, and throughout this disclosure, refers to an individual engaging a device according to embodiments of the invention wherein the engagement is a result of their personal use of the device or having another individual using the device upon them or in conjunction with their use of the device.

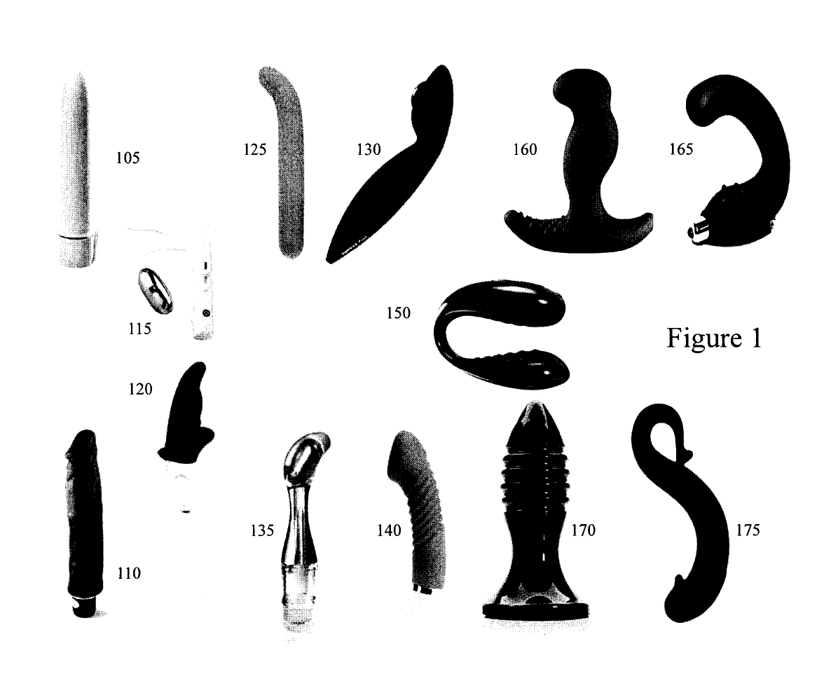

Referring to FIG. 1 there are depicted examples of devices according to the prior art including standard vibrator 105, penis-like vibrator 110, bullet vibrator 115 and novelty vibrator 120 which are designed to provide vibration but without specific consideration of the user's g-spot. Vibrators for primarily female G-spot use include first to fourth shaped vibrators 125 through 140 respectively which are shaped to access the G-spot when inserted. Also depicted is a We-Vibe™ 150 which provides vibratory stimulation to a female user of both their G-spot and clitoris through the two ends. Further, the profile of We-Vibe™ 150 allows penetration to occur at the same time so that it may be used by a couple or in conjunction with another vibrator or dildo as envisioned by the inventor. Plug vibrator 170 represents an anal vibrator exploiting vibratory triggered and physical dilation triggered nerve sensations to a user, either male or female. However, with respect to the male G-spot then exemplary first and second male vibrators 160 and 165 are intended to provide vibratory stimulation to a male user upon insertion and engage against the appropriate portion of the user to stimulate the prostate. However, as noted supra the density of nerve endings is such that anal stimulation may also be sought by a female and hence vibrators such as curved vibrator 175 provide a female user with vibratory sensations with these direct more specifically. Accordingly, all of these devices exploit medium—high frequency low—moderate amplitude stimulation.

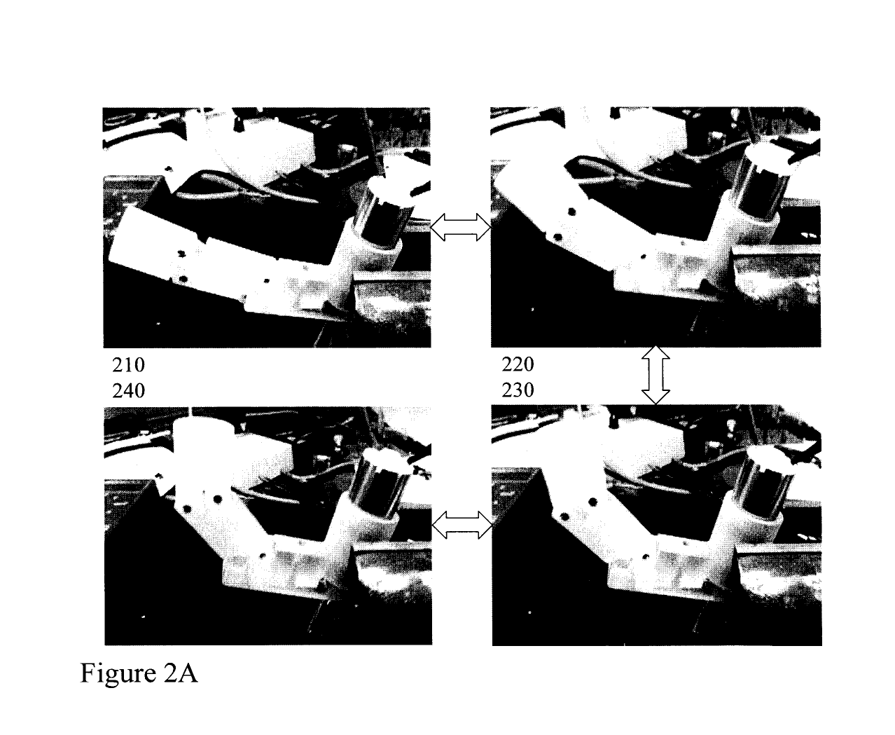

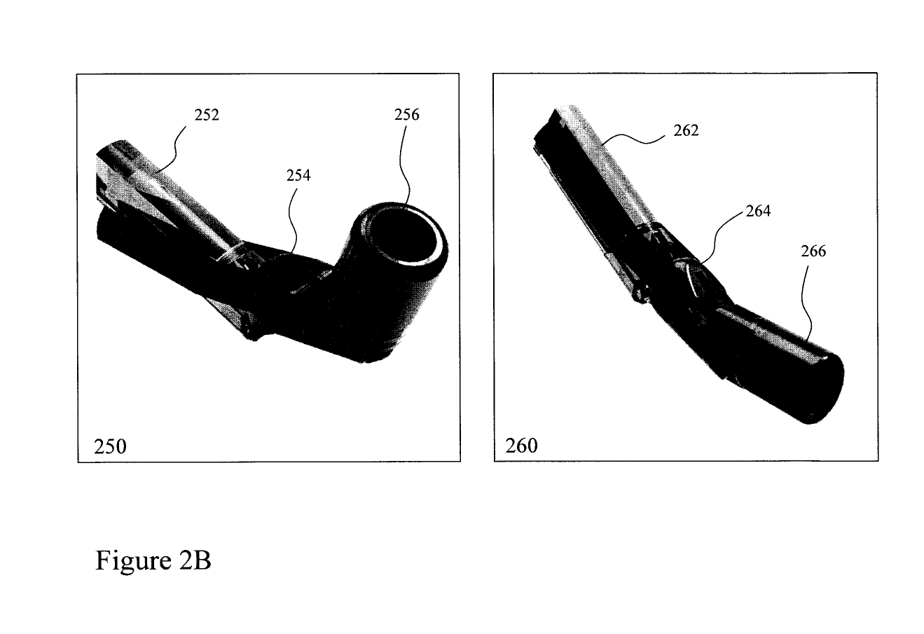

Now referring to FIG. 2A there is depicted a flexural device actuator according to an embodiment of the invention in first to fourth images 210 through 240 respectively. Under action of a motor, on the right hand side of the flexural device actuator the actuator, progressively raises, from “rest” state depicted in first image 210, to raised state, as depicted in fourth image 240, through second and third images 220 and 230 sequentially before the process is reversed and then repeats with each subsequent action of the motor. Accordingly, it would be evident to one skilled in the art that the flexural device actuator under the motion of the motor mimics the motion of a human finger. Accordingly such an actuator within an elastomeric, silicone, or other covering may provide mechanical stimulation to a user or an individual on whom a user uses the actuator. As depicted the motion presented in first to fourth images 210 through 240 respectively represents an effective “come hither” or “come here” motion as discussed supra such as upon the male or female G-spots.

Referring to FIG. 2B there are depicted computer generated models of first and second flexural device actuators 250 and 260 respectively according to embodiments of the invention. First flexural device actuator 250 exploiting an off-axis motor drive, not shown for clarity, housed with first housing 256 which engages via first actuator 254 to the first flexure element 252 which would engage against the individual upon whom the device comprising first flexural device actuator 250 is used or they use upon themselves. Second flexural device actuator 260 exploits an in-line motor drive, not shown for clarity, housed with second housing 266 which engages via second actuator 264 to the second flexure element 262 which would engage against the individual upon whom the device comprising second flexural device actuator 260 is used or they use upon themselves.

The off-axis drive may, for example, exploit the rotary motion of a motor directly or convert the rotary motion to linear motion via a cam mounted to the motor shaft but off-axis. Examples of such rotary motors may include for example permanent magnet motors, brushed DC motors, brushless DC motors, switched reluctance motors, coreless or ironless DC motors, printed armature or pancake DC motors, universal motors, sliding rotor AC motors, synchronous electric motors, induction motors, singly fed or doubly fed electric motors, torque motors, and stepper motors. The in-line drive may, for example, exploit a linear motor examples of which include for example an induction motor, synchronous motor, homopolar motor, or piezoelectric motor. Alternatively, a linear actuator may be exploited in conjunction with a rotary motor, such as for example in so-called traveling-nut or traveling-screw linear actuators. Alternatively, hydraulic or pneumatic actuations may be exploited discretely or in conjunction with an electrical motor.

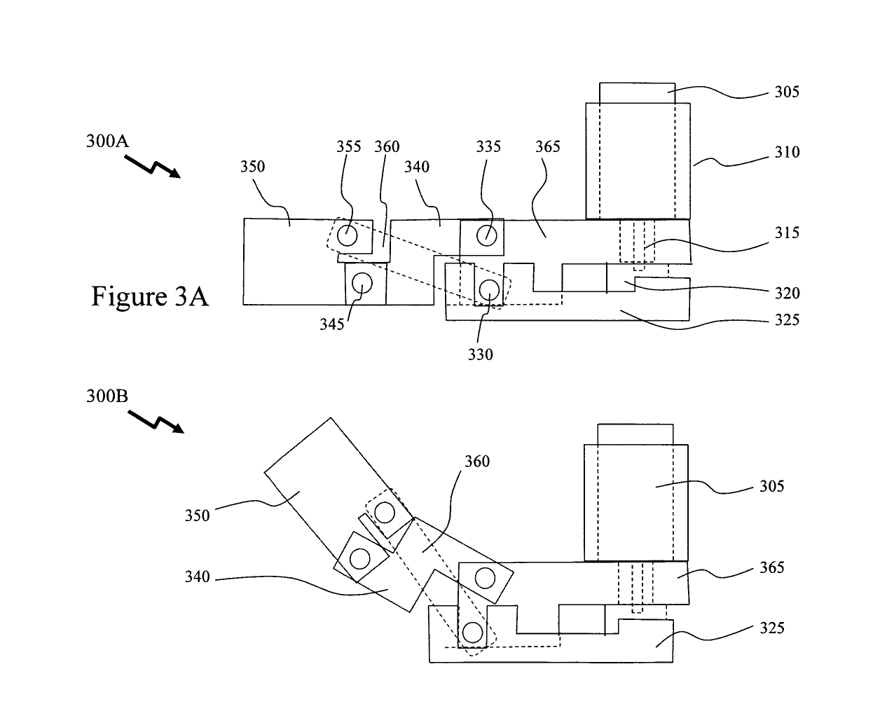

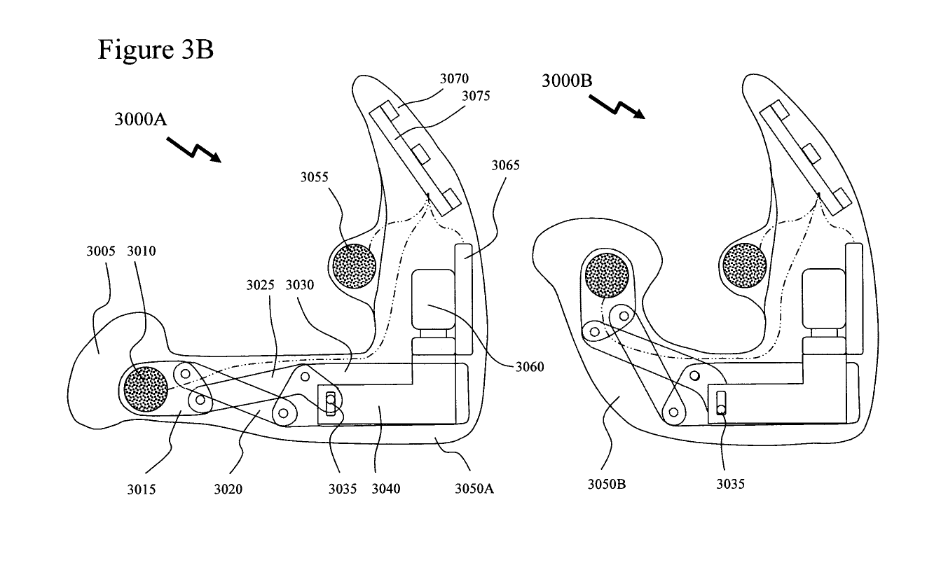

Referring to FIG. 3A depicts a flexural actuator according to an embodiment of the invention as depicted in FIG. 2A in exemplary first and second end of motion states 300A and 300B respectively. As depicted the flexural actuator comprises a motor 305 within a housing 310 wherein the shaft 315 of the motor engages a cam 320 wherein it is mounted off-axis to the cam 320 which is engaged with slider 325 such that rotary motion of the shaft 315 results in motion of the slider 325 linearly in a direction perpendicular to the shaft 315. Housing 310 is also coupled to body 365 which has first and second pivot mounts 330 and 335. First pivot mount 330 retaining a first end of a push-rod 360 whilst second pivot mount 335 retains a first end of first flexure element 340. The first flexure element 340 at its other end has a third pivot mount 345 to which is retained second flexure element 350 which also has fourth pivot mount 355 at the same end as third pivot mount 345 but towards the top rather than the bottom. Fourth pivot mount 355 engages the second distal end of the push-rod 360. Accordingly, as the slider 325 moves then it pushes the push-rod 360 thereby causing the first and second flexural elements 360 and 350 respectively to pivot about the second and third pivot mounts 335 and 345 respectively until the maximum slider motion results in second end of motion state 300B wherein the process reverses as the slider 325 returns to its initial position, pulling the push-rod 360, until the flexural actuator returns to first end of motion state 300A.

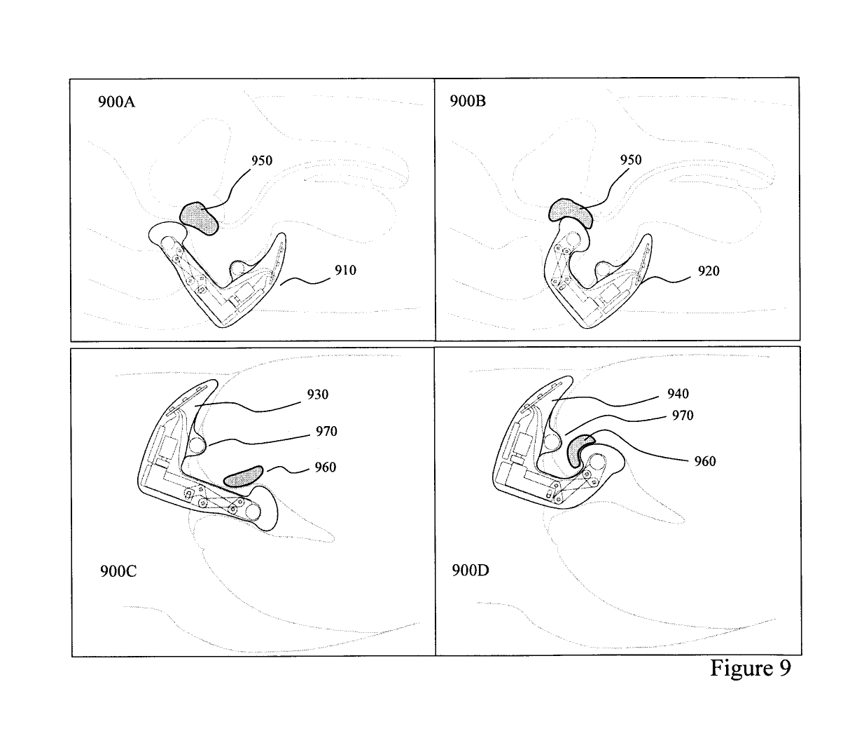

Referring to FIG. 3B there is depicted a device in first and second configurations 3000A and 3000B respectively. This device is also depicted in FIG. 9 as employed by male and female users. Throughout this specification a device in a configuration such as first configuration 3000A, wherein the flexural actuator is essentially extended, is referred to as being in an “open” configuration whilst second configuration 3000B, wherein the flexural actuator is essentially “bent”, is referred to as being in a “closed” configuration. As depicted in first configuration 3000A the device comprises an outer body, depicted as first skin 3050A, with a bulbous end 3005. Within the outer body 3050A are a plurality of batteries 3075 coupled to a controller 3070, wherein the batteries 3075 may for example be inductively charged to remove the requirement for an external electrical socket/plug. The controller 3070 is coupled to first and second vibration actuators 3055 and 3010 respectively as well as motor controller 3065. First vibration actuator 3055 is disposed within the outer body 3050A discretely whilst second vibration actuator 3010 is disposed within actuator end portion 3015. Actuator end portion 3015 is coupled to first and second flexural arms 3020 and 3025 which are themselves coupled to first actuator body element 3030. Second flexural arm 3025 is also coupled to second actuator body element 3040 via sliding mount 3035.

Relative motion of first and second actuator body elements 3030 and 3040 therefore results in pivoting of first and second flexural arms 3020 and 3025, as a result of second flexural arm 3025 being restrained against second actuator body element 3040 through sliding mount 3035, and thereby pivoting the actuator end portion 3015 relative to the first and second actuator body elements 3030 and 3040 such that the device shifts towards second configuration 3000B wherein the outer body becomes second skin 3050B. Accordingly, under direction of the motor controller 3065 the motor 3060 drives relative motion between the first and second actuator body elements 3030 and 3040 respectively such that the device can transition between first and second configuration 3000A and 3000B according to the programming executed by the motor controller 3065. This program may for example be a simple sinusoidal fixed frequency, multiple frequency operation, variable amplitude, aperiodic operation, fixed pressure, constant contact—variable pressure, and a combination thereof. Controller 3070 may also control, in conjunction with the flexural actuator, the operational conditions for one or both of the first and second vibration actuators 3055 and 3010 respectively. These conditions may be include for example active, passive, fixed frequency, variable frequency, fixed amplitude, and variable amplitude for each of the first and second vibration actuators 3055 and 3010 respectively. Additionally, the operational conditions of the first and second vibration actuators 3055 and 3010 respectively may be varied simultaneously with variations of the flexural actuator or independent of variations of the flexural actuator.

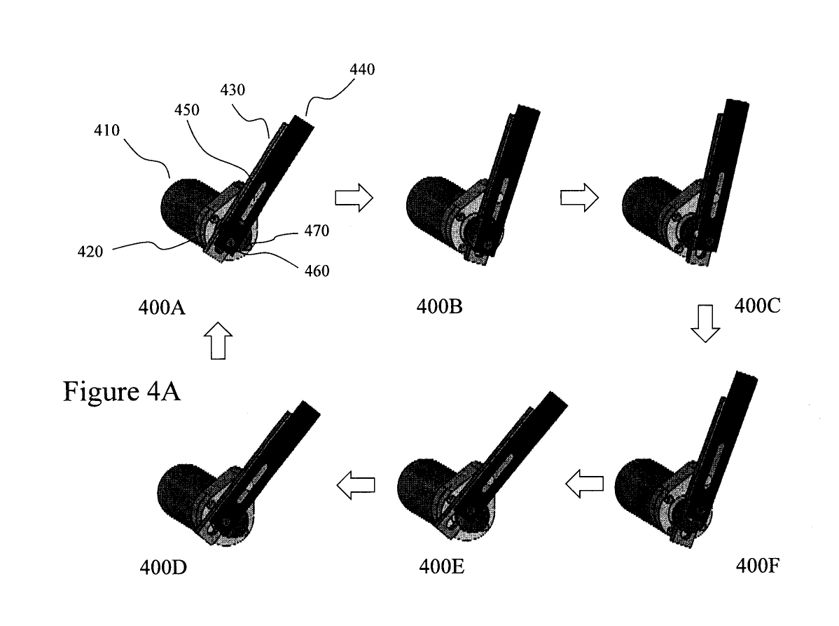

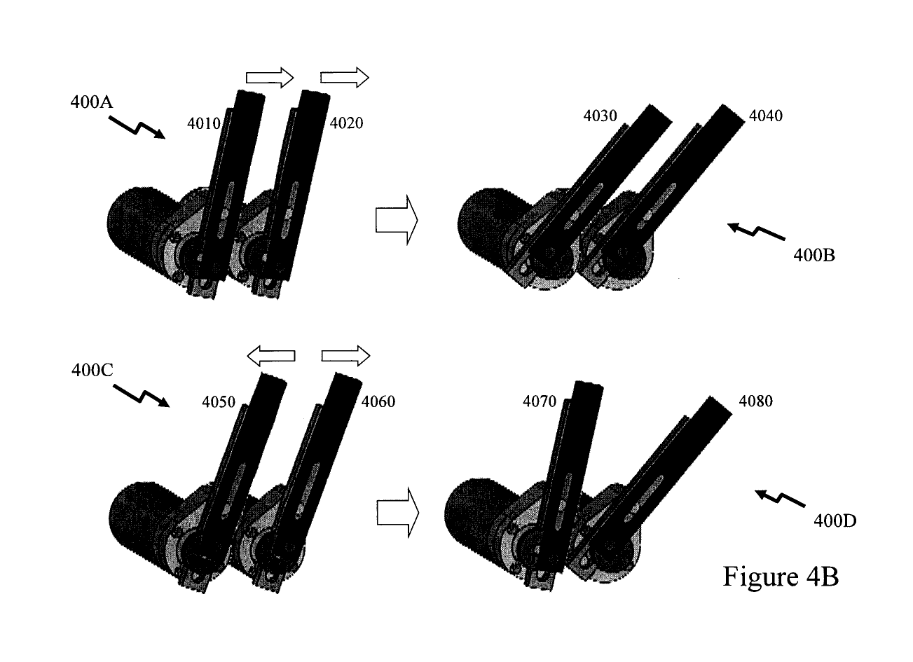

Now referring to FIG. 4A there is depicted an actuator supporting wiper or slider motion according to an embodiment of the invention in first to sixth states 400A through 400F respectively which represent intermediate points upon a cyclic operation sequence under continued motor action in the same direction. Accordingly, wiper or slider motion is achieved with continuous motor 410 operation without the requirement to alternate the motion of the motor 410. Mounted to the body of motor 410 is mounting plate 420 with post 450 disposed towards one end away from the body of the motor 410. Mounted above the mounting plate 420 is first slider 430 which mounts to post 450 but has a slot where it mounts upon the shaft of the motor 410. A cam 470 is mounted to the shaft over the first slider 430 with a second post 460. A second slider 440 is mounted atop these elements and is attached to second post 460 with a slot where the second slider 440 overlays first slider 430 and post 450. Accordingly, rotation of the shaft of the motor results in the cam 470 rotating such that the off-axis second post 460 drives the second slider 440 whilst the cam 470 and intermediate mount, not shown for clarity, drive the first slider 430. Accordingly, as the shaft rotates the actuator progresses through first to sixth states 400A through 400F respectively such that the second slider 440 moves both linearly away from the body of the motor 410 and tilts through the cam 470 motion such that the second slider 440 performs a wiper motion. Adjustment in position of the post 450, second post 460, and first and second sliders 430 and 440 alternately provides for a slider motion, a wiper motion, or a combination thereof. Based upon these adjustments a device may be provided with one motion type or be configurable between multiple motion types.

Now referring to FIG. 4B there are depicted first to fourth actuator configurations 400A through 400D respectively wherein actuators such as described supra in respect of FIG. 4A supporting wiper or slider motions according to embodiments of the invention. First actuator configuration 400A comprises first and second actuators 4010 and 4020 which are driven by motors such that with rotation of the motors their motions are in the same direction resulting in their motion towards second actuator configuration 400B as third and fourth actuators 4030 and 4040 respectively such that continuous operation of the motors results in the wipers moving between first and second configurations 400A and 400B respectively in a continuous wiping motion. Alternatively, fifth and sixth actuators 4050 and 4060 in third actuator configuration 400C respectively may transition to seventh and eighth actuators 4070 and 4080 in fourth actuator configuration 400D such that repeated action of the motors results in the wipers moving between third and fourth actuator configurations 400C and 400D respectively such that the wipers perform a scissor like action. It would be evident that by appropriate control therefore allows for either lateral wiping or lateral scissor actions. Accordingly, if the actuators are encased with elastomeric, silicone, or other materials these can act as finger like stimulators to a user directly or an individual upon whom a device incorporating the actuators is used.

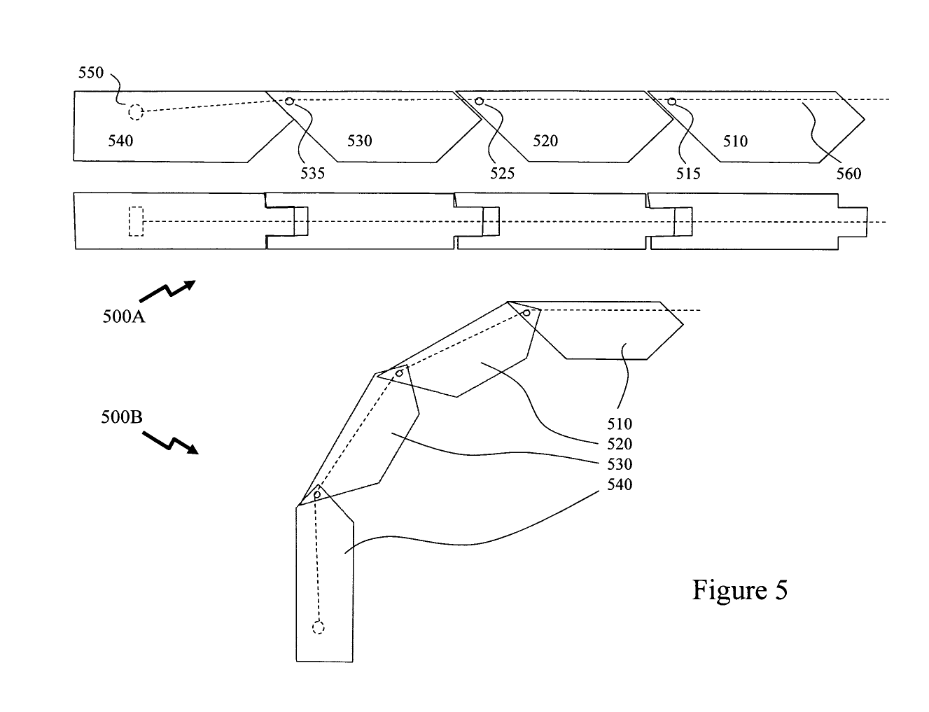

Referring to FIG. 5 there is depicted a flexural actuator according to an embodiment of the invention exploiting an alternate actuation mechanism. As depicted in first and second configurations 500A and 500B respectively representing the limits of motion the flexural actuator comprises first to third elements 510 through 530 with end element 540. Accordingly, these elements being connected via first to third pivots 515 to 535 respectively with a cable 560 running through connected to end mount 550. Accordingly, as the cable 560 is pulled away from flexural actuator the first to third elements 510 through 530 respectively and end element 540 pivot upon first to third pivots 510 to 535 respectively transitioning the flexural actuator to second configuration 500B. Motion of the cable 560 may be controlled through a motor, not shown for clarity, such as those described supra in respect of AC, DC, and linear motors for example. Optionally, depending upon design requirements, dimensions, etc multiple motors may be employed disposed within one or more elements of the flexural actuator.

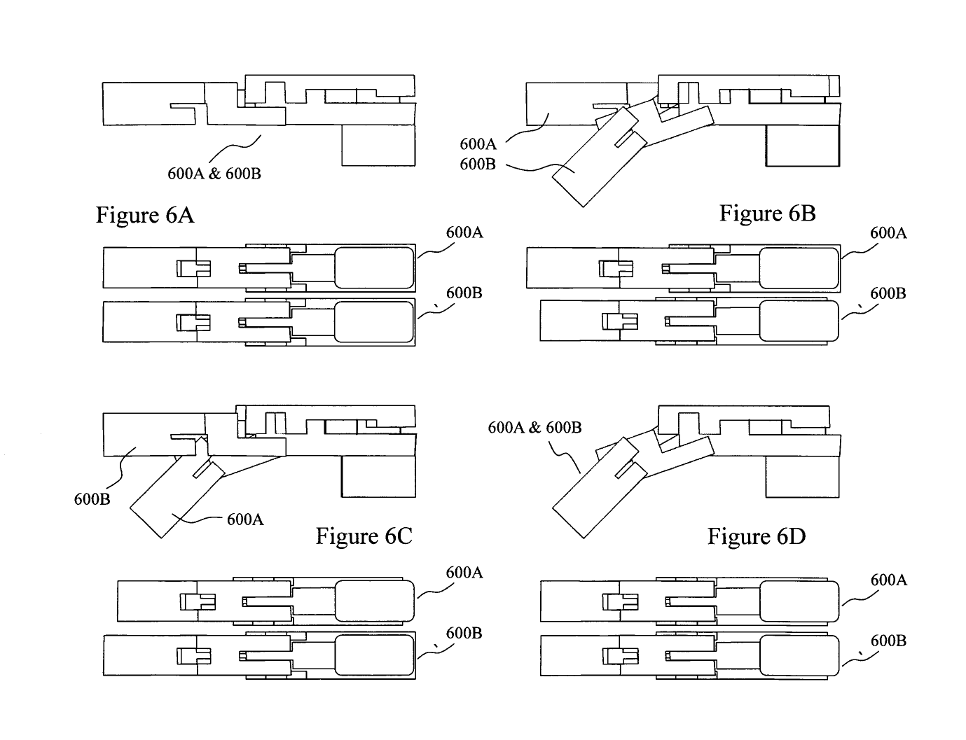

Now referring to FIGS. 6A through 6D there are depicted different actuation configurations for a pair of flexural actuators 600A and 600B. Flexural actuators 600A and 600B being for example implemented according to an embodiment of the invention as depicted in FIG. 5 supra. In FIG. 6A the pair of flexural actuators 600A and 600B are depicted in “open” configuration which may for example represent a configuration when a device comprising at least the pair of flexural actuators 600A and 600B is inserted into an orifice of the individual, e.g. their anus or vagina. In FIG. 6B the second flexural actuator has 600B has been transitioned to “closed” configuration such that it is bent like a finger, whilst in FIG. 6C the first flexural actuator 600A has been transitioned to the “closed” configuration with the second flexural actuator 600A “open.” Finally, in FIG. 6D both first and second flexural actuators 600A and 600B respectively have been transitioned to the “closed” configuration. Accordingly, under control of first and second motors and a controller, not shown for clarity, connected to first and second flexural actuators 600A and 600B respectively these may be selectively translated between “open”, “closed”, and “intermediate” positions such that the actuators present varying pressure and contact to a region of the user such as for example the male or female G-spot. In contrast to vibrators the flexural actuators provide varying pressure stimulation at lower frequencies but increased pressure. It would be evident that other intermediate positions for each of the pair of flexural actuators 600A and 600B may be established.

It would be evident to one skilled in the art that according to the programming provided to a controller interfaced to the pair of flexural actuators 600A and 600B that a range of motions and sensations/stimuli may be provided to a user including, but not limited, continuous or periodic engagement of one or both actuators against the user's body in a manner similar to digit based stimulation by another individual or the user themselves. It would also be evident that the range of motion during actuation may be varied together with the pressure applied to the user such that in some instances contact may be maintained with varying pressure whilst in others contact may be periodic together with the pressure applied. Further, profiles of contact/pressure may vary including, but not limited to, periodic, sinusoidal, digitally pulsed, and spiked pulses.

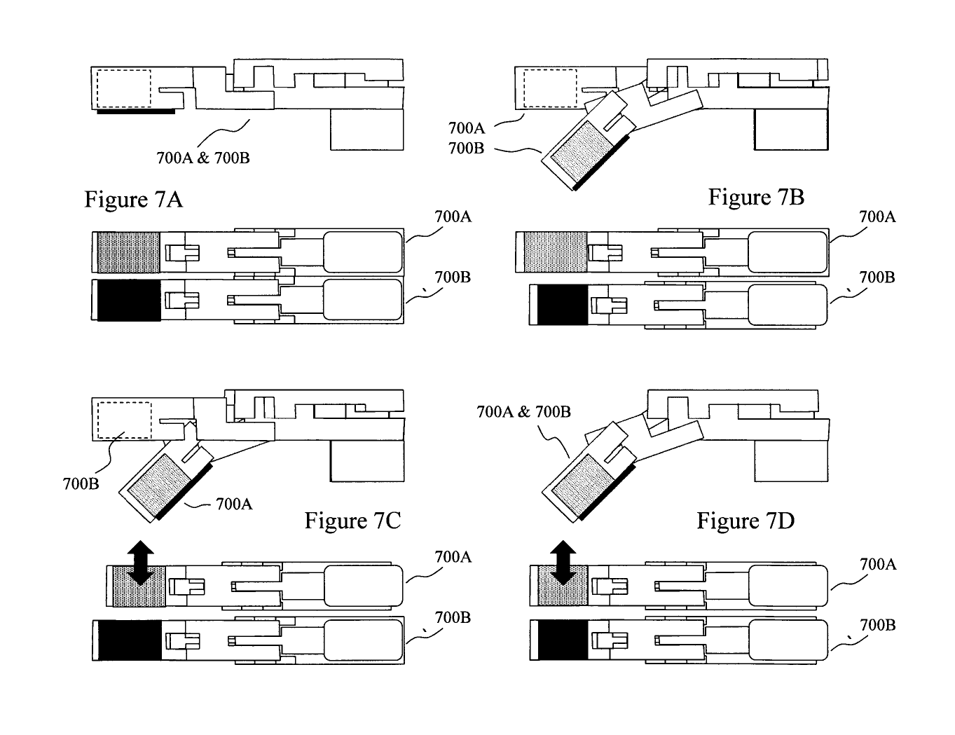

Referring to FIGS. 7A through 7D there are depicted first to fourth actuation configurations for a pair of flexural actuators 700A and 700B according to an embodiment of the invention with vibratory and wiper augmentation. As with FIGS. 6A through 6D these configurations present the pair of actuators 700A and 700B in “open”, one “closed”, the other “closed”, and both “closed.” It would be evident that other intermediate positions for each of the pair of flexural actuators 700A and 700B may be established. However, first flexural actuator 700A includes a wiper element 710 with wiper controller 715 and second flexural actuator 700B includes a vibrator element 720 with vibrator controller 725. Accordingly, when first flexural actuator 700A is transitioned to “closed” such as depicted in third and fourth configurations in FIGS. 7C and 7D respectively then in addition to providing pressure against the body of a user the wiper element 710 under action controlled by wiper controller 715 may provide lateral motion of the first flexural actuator 700A against the user's body. Likewise when the second flexural actuator 700B is transitioned to “closed” such as depicted in second and fourth configurations in FIGS. 7B and 7D respectively then in addition to providing pressure against the body of a user the vibrator element 720 under action controlled by vibrator controller 725 may provide vibratory action of the second flexural actuator 700B against the user's body. Accordingly, for example in fourth configuration in FIG. 7D then first and second actuators 700A and 700B may provide periodic pressure to a G-spot whilst wiper controller 715 provides additional rubbing like motion and vibrator controller 725 provides vibration.

It would be evident to one skilled in the art that according to the programming provided to a controller interfaced to the pair of flexural actuators 700A and 700B that a range of motions and sensations/stimuli may be provided to a user including but not limited, periodic engagement of one or both actuators against the user's body in a manner similar to digit based stimulation by another individual or the user themselves, pressure engagement of actuator with rubbing motion, pressure engagement of actuator with vibration, alternating pressure engagement with rubbing and vibratory motions. Optionally, wiper element 710 and wiper controller 715 may provide for motion in two axes representing a radially varying rubbing like stimulation. It would also be evident that the range of motion during actuation may be varied together with the pressure applied to the user such that in some instances contact may be maintained with varying pressure whilst in others contact may be periodic together with the pressure applied. Further, profiles of contact/pressure may vary including, but not limited to, periodic, sinusoidal, digitally pulsed, and spiked pulses.

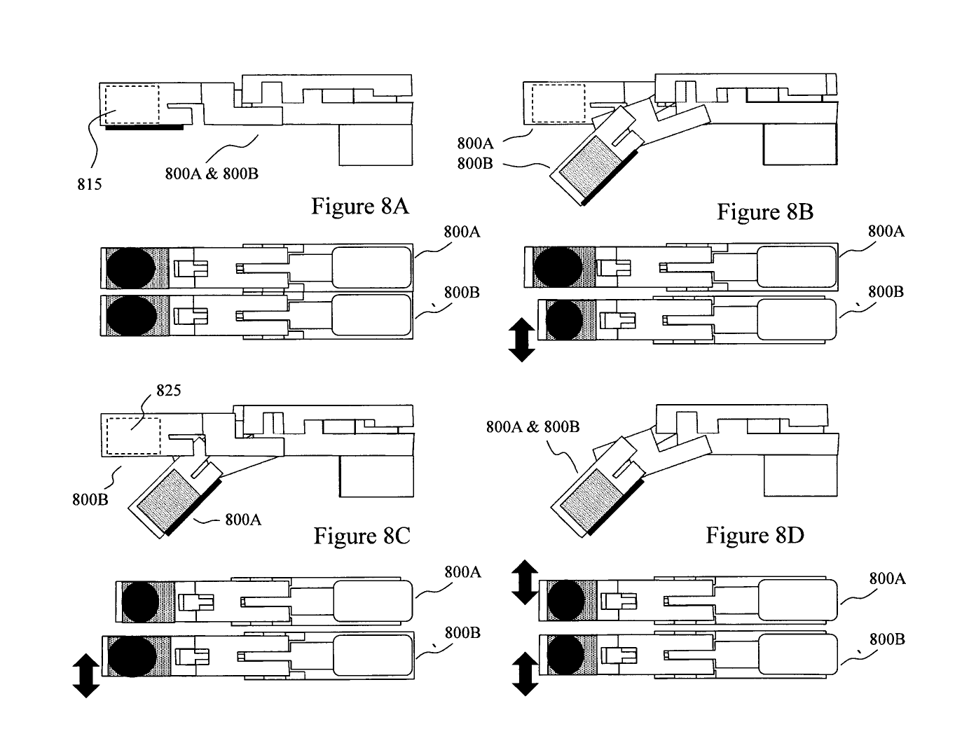

Now referring to FIGS. 8A through 8D there are depicted first to fourth actuation configurations for a pair of flexural actuators 800A and 800B according to an embodiment of the invention with vibratory and wiper augmentation. As with FIGS. 6A through 6D and FIGS. 7A through 7D these configurations present the pair of actuators 700A and 700B in “open”, one “closed”, the other “closed”, and both “closed.” Each of the flexural actuators comprises a wiper element 810 with wiper controller 815 and flexural actuator 800B includes a vibrator element 820 with vibrator controller 825. Accordingly, when either or both of the first and second flexural actuators 800A and 800B respectively is transitioned to “closed” such as depicted in second through fourth configurations in FIGS. 8B through 8D respectively then, in addition to providing pressure against the body of a user through the flexural actuator, one or both of the wiper elements 810 may under action controlled by the respective wiper controller 815 provide lateral motion of the respective first and/or second flexural actuators 800A and 800B respectively against the user's body. Likewise when either or both of the first and second flexural actuators 800A and 800B respectively is transitioned to “closed” such as depicted in second through fourth configurations in FIGS. 8B through 8D respectively then, in addition to providing pressure against the body of a user through the flexural actuator, one or both of the vibrator elements 820 may under action controlled by the respective vibrator controller 825 provide vibratory action of the respective first and/or second flexural actuators 800A and 800B respectively against the user's body.

It would be evident to one skilled in the art that by design of the first and/or second flexural actuators 800A and 800B together with the wiper elements 810 that the resulting action of applying constant pressure with bent “fingers” and generating lateral motion is un-natural and cannot be produced by an individual with their fingers when stimulating either their own or another's G-spot. It would be evident to one skilled in the art that according to the programming provided to a controller interfaced to the pair of flexural actuators 800A and 800B, as well as the wiper controllers 815 and vibrator controllers 825, that a range of motions and sensations/stimuli may be provided to a user including but not limited, periodic engagement of one or both actuators against the user's body in a manner similar to digit based stimulation by another individual or the user themselves, pressure engagement of actuator with rubbing motion, pressure engagement of actuator with vibration, alternating pressure engagement with rubbing and vibratory motions. Optionally, wiper elements 810 and wiper controllers 815 may provide for motion in two axes representing a radially varying rubbing like stimulation. It would also be evident that the range of motion during actuation may be varied together with the pressure applied to the user such that in some instances contact may be maintained with varying pressure whilst in others contact may be periodic together with the pressure applied. Further, profiles of contact/pressure may vary including, but not limited to, periodic, sinusoidal, digitally pulsed, and spiked pulses.

Whilst the embodiments of the invention described supra in respect of FIGS. 7A through 7D and FIGS. 8A through 8D have been described primarily in respect of G-spot stimulation it would be evident to one skilled in the art that motions applying pressure, lateral motions, and vibration may be employed to stimulate other parts of the human body including, but not limited to, nipples, clitoris, testes, vagina, and penis.

Now referring to FIG. 9 there are depicted first and second male schematics 900A and 900B of a device exploiting a flexural actuator such as described supra in respect of FIG. 3A or FIG. 5 for example. As depicted the device has a similar construction to that of the device described supra in respect of FIG. 3B although other configurations such as described below may be employed. Within first and second male schematics 900A and 900B the device varies from first state 910 to second state 920, wherein these states correspond to “open” and “closed” states 3000A and 3000B as described supra in respect of FIG. 3B. As the device varies from first state 910 to second state 920 it applies varying pressure to the male prostate 950. Similarly referring to first and second female schematics 900C and 900D the device varies from first female state 930 to second female state 940, wherein these states correspond to “open” and “closed” states 3000A and 3000B as described supra in respect of FIG. 3B. As the device varies from first female state 930 to second female state 940 it applies varying pressure to the female G-spot 960. Within first and second female states it can also be seen that the device impinges against the region of the female corresponding to the clitoris such that the vibration actuator may apply stimulation to the clitoris at the same time as the stimulation to the G-spot 960.

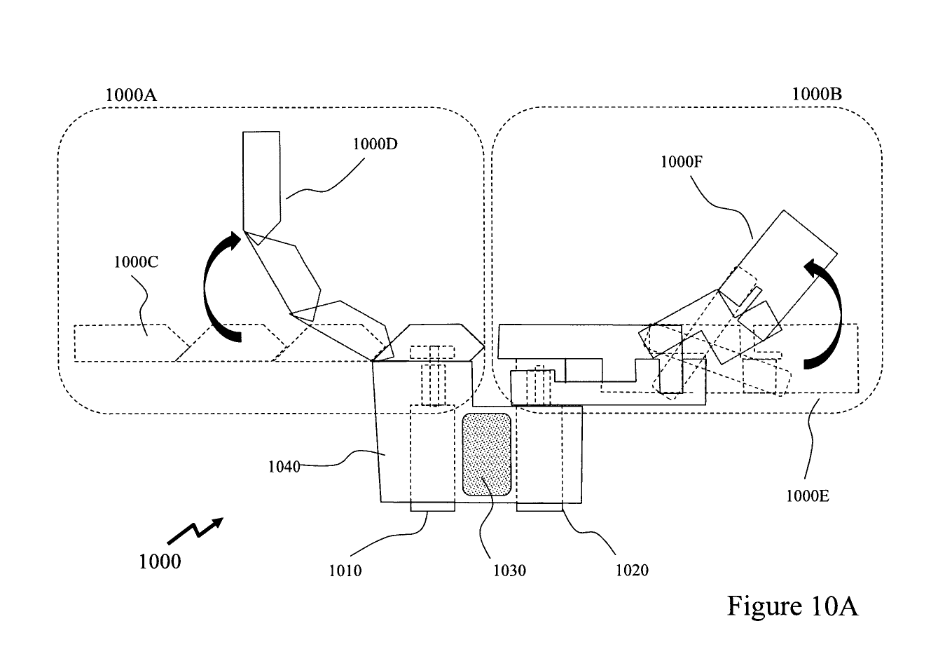

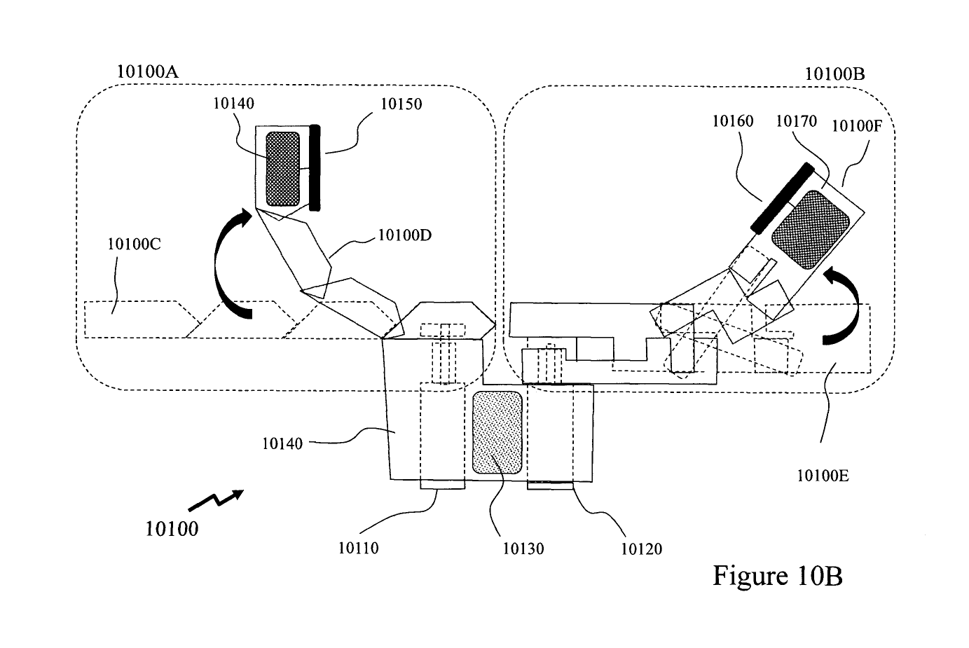

Referring to FIG. 10A there is depicted a mechanical configuration 1000 for a pair of flexural actuators 1000A and 1000B according to an embodiment of the invention. As depicted first flexural actuator 1000A exploits a flexural actuator such as described supra in respect of FIG. 5 whilst second flexural actuator 1000B exploits a flexural actuator such as described supra in respect of FIG. 3A. First flexural actuator 1000A is mounted to body element 1040 and controlled via controller 1030 which controls first motor 1010. Second flexural actuator 1000B is also mounted to body element 1040 and similarly controlled via controller 1030 which also controls second motor 1020. Accordingly, the controller 1030 may execute a program taking the mechanical configuration from an “OFF” state, wherein the first and second flexural actuators 1000A and 1000B are in first and second “open” configurations 1000C and 1000E respectively, to an “ON” state. In “ON” state the first and second flexural actuators 1000A and 1000B are in first and second “closed” configurations 1000D and 1000F respectively wherein they, may for example, be providing pressure to a user's body. For example a female user may employ a device containing mechanical configuration 1000 to provide stimulation to their G-spot, via first flexural actuator 1000A for example, and their clitoris, via second flexural actuator 1000B for example.

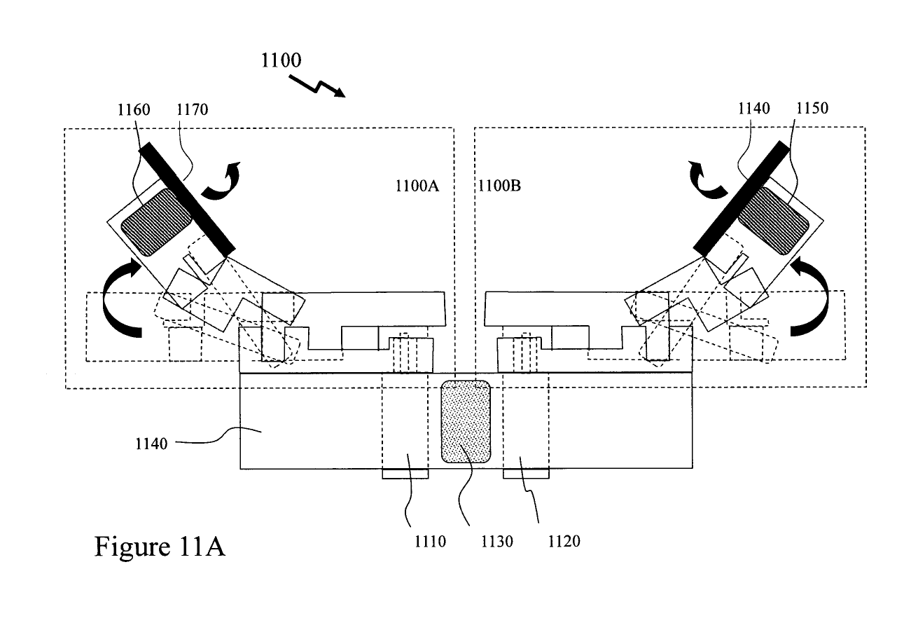

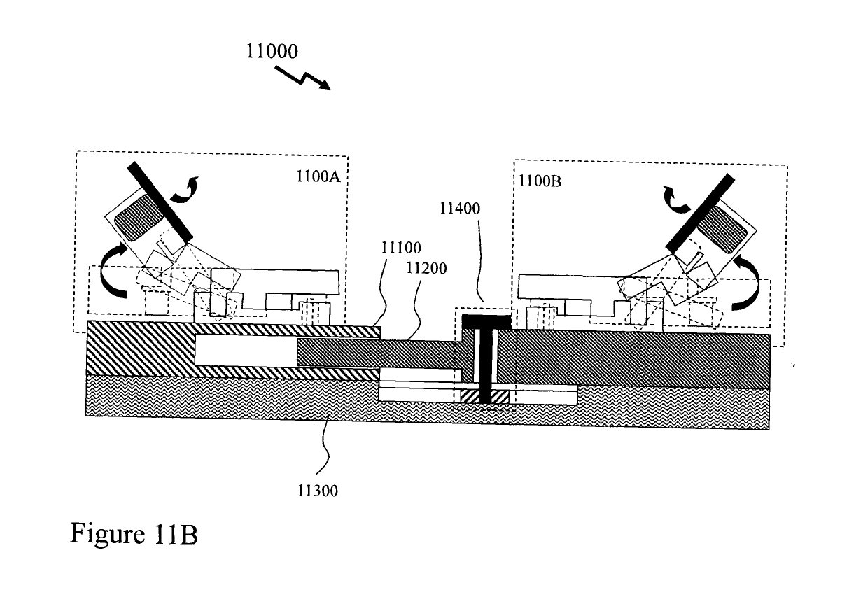

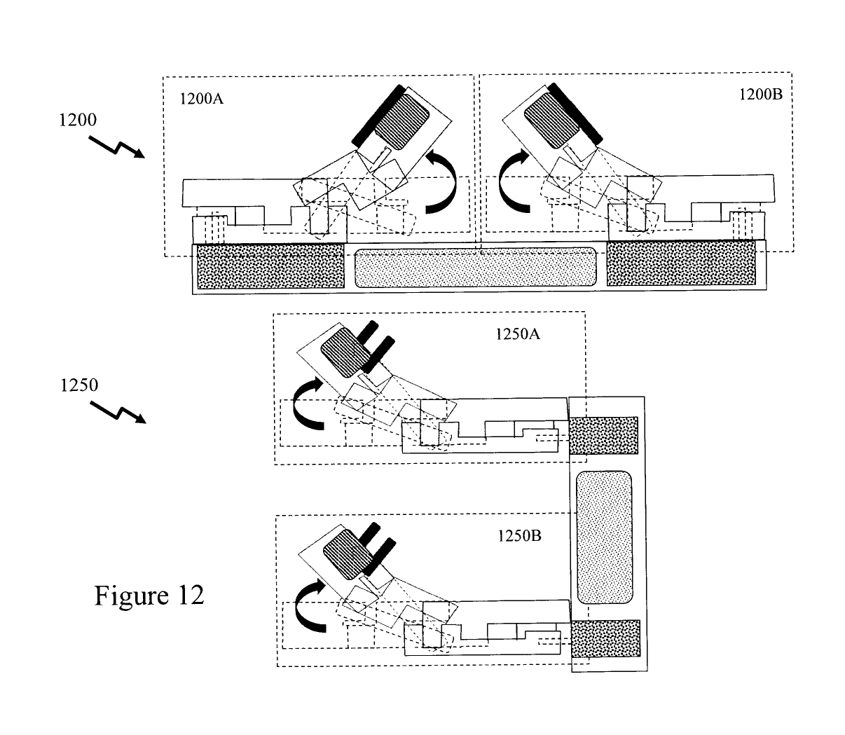

Alternatively, mechanical configuration 1000 may employ a pair of first flexural actuators 1000A exploiting flexural actuators such as described supra in respect of FIG. 5 or it may employ a pair of second flexural actuators 1000B exploiting flexural actuators such as described supra in respect of FIG. 3A. Embodiments of the later being depicted in FIGS. 11 and 12 below in respect of alternate augmentations and configurations which may also be implemented using flexural actuators such as described supra in respect of FIG. 5 with or without augmentation. Optionally, by adjusting the separation between first and second flexural actuators 1000A and 1000B variations in the physiology and physical attributes of users may be adjusted due to variations in effective distance, such as for example from the clitoris to their G-spot. Different separations may in some embodiments of the invention be achieved by exploiting different body elements 1040 or by providing body element 1040 with user adjustable settings such that the physical position of either/both of first and second flexural actuators 1000A and 1000B may be established by the user.

Now referring to FIG. 10B there is depicted an augmented configuration 10100 for a pair of flexural actuators 10100A and 10100B according to an embodiment of the invention. As depicted first flexural actuator 10100A exploits a flexural actuator such as described supra in respect of FIG. 5 whilst second flexural actuator 10100B exploits a flexural actuator such as described supra in respect of FIG. 3A. First flexural actuator 10100A is mounted to body element 10140 and controlled via controller 10130 which controls first motor 10110. Second flexural actuator 10100B is also mounted to body element 10140 and similarly controlled via controller 10130 which also controls second motor 10120. Accordingly, the controller 10130 may execute a program taking the mechanical configuration from an “OFF” state, wherein the first and second flexural actuators 10100A and 10100B are in first and second “open” configurations 10100C and 10100E respectively, to an “ON” state. In “ON” state the first and second flexural actuators 10100A and 10100B are in first and second “closed” configurations 10100D and 10100F respectively wherein they, may for example, be providing pressure to a user's body. For example a female user may employ a device containing mechanical configuration 10100 to provide stimulation to their G-spot, via first flexural actuator 10100A for example, and their clitoris, via second flexural actuator 10100B for example. However, unlike mechanical configuration 1000 augmented configuration 10100 now comprises first and second vibrator elements 10150 and 10160 as part of the first and second flexural actuators 10100A and 10100B respectively in conjunction with first and second vibrator controllers 10140 and 10170 respectively. Accordingly, in addition to provide physical pressure stimulation the user may experience vibratory stimulations through either or both first and second flexural actuators 10100A and 10100B respectively. Optionally, first and second vibrator controllers 10140 and 10170 respectively may form part of controller 10130. Optionally, control signals for either/both of the first and second vibrator elements 10150 and 10160 may be derived for example from programming within controller 10130, programming provided to controller 10130 from a remote source, or in response to a source such as a multimedia file or audio file for example.

Now referring to FIG. 11A there is depicted a device configuration 1100 for a pair of flexural actuators 1100A and 1100B according to an embodiment of the invention. As depicted the pair of flexural actuators 1100A and 1100B exploit flexural actuators such as described supra in respect of FIG. 3A. First and second flexural actuators 1100A and 1100B are similarly mounted to body element 1140 and controlled via controller 1130 which controls first and second motors 1110 and 1120 respectively for the first and second flexural actuators 1100A and 1100B such that can be varied in position between “OFF” and “ON” states according to the program of the controller 1130 discretely or in combination with external inputs and/or triggers. It would also be evident that controller 1030 may execute a series of movements for the pair of flexural actuators 1100A and 1100B such that they each provide alternating pressure which may be similar on each of the pair of flexural actuators 1100A and 1100B respectively, may be different, may be one or other only, may be synchronized to each other, or may be asynchronous to one another for example. Device configuration 1100, unlike mechanical configuration 1000 and augmented configuration 1000, incorporates first and second wiper elements 1170 and 1140 respectively within the first and second flexural actuators 1100A and 1100B respectively together with first and second wiper drivers 1160 and 1150 respectively. Accordingly, in addition to providing pressure to a region of the body through one or both of the pair of flexural actuators 1100A and 1100B additional stimulation through making the actuator or actuators move may be provided. As discussed supra in respect of FIG. 4 such wiper elements may provide one axis or two axis motion.

It would also be evident that the functional elements of device configuration 1100 may be combined with functional elements of augmented configuration 1000 and/or mechanical configuration 1000 so that different actuators may be employed for mechanical pressure generation to the body as well as different combinations of lateral and/or vibratory motion may be provided within the pair of actuators as well as being controlled through different control sequences from a controller or controllers. For example, an actuator for G-spot stimulation may comprise pressure actuator and vibrator whilst an actuator for clitoral stimulation may comprise pressure actuator and lateral motion. Other combinations and options would be evident to one skilled in the art.

Now referring to FIG. 11B there is depicted a device configuration 11000 for a pair of flexural actuators 1100A and 1100B according to an embodiment of the invention. Flexural actuators 1100A and 1100B being as described supra in respect of FIG. 11A. However, as noted supra the female G-Spot is typically described as being located one to three inches (2.5 to 7.6 cm) up the front (anterior) vaginal wall between the vaginal opening and the urethra. Whilst the motion of the flexural actuators 1100A and 1100B provide for some variations in female anatomy the extent of this is determined by the size and design of the flexural actuators 1100A and 1100B. Accordingly, in order to accommodate typical variations in female anatomy it is likely that a series of devices may be manufactured and marketed with different spacings between the flexural actuators 1100A and 1100B. Alternatively, device configuration 11000 may exploit first body portion 11100 to which first flexural actuator 1100A is mounted and second body portion 11200 to which second flexural actuator 1100B is mounted. Both first and second body portions 11100 and 11200 being mounted to body 11300. However, as depicted second body portion 11200 may be translated relative to the body 11300 and hence first flexural actuator 11100 and locked into position through locking mechanism 11400. It would be evident to one skilled in the art that different locking mechanisms may be employed as well as means of providing relative motion between the first and second body portions 11100 and 11200 respectively on the body 11300. These may, for example, provide for continuous or discontinuous position setting, require the user to twist and adjust before reversing the twist to lock the device, require the user to tighten a knob or screw to lock the device, or provide for spring loading to keep the elements retained.

Referring to FIG. 12 there are depicted mechanical configurations for a pair of flexural actuators for according to an embodiment of the invention with vibratory augmentation. As depicted first mechanical configuration 1200 comprises first and second flexural actuators 1200A and 1200B exploiting flexural actuators such as described supra in respect of FIG. 3A. In contrast to preceding configurations depicted in respect of FIGS. 9 through 11 the first and second flexural actuators 1200A and 1200B are orientated such that if the device comprising the first mechanical configuration 1200 was a double-ended dildo or vibrator being used by two females then the first and second flexural actuators 1200A and 1200B would contact the clitoral region of each female providing pressure based stimulation. If each of the first and second flexural actuators 1200A and 1200B also comprises either/or a vibrator element and wiper element then in addition to providing pressure based stimulation then additional mechanical action simulating rubbing or vibration would be imparted to the user(s) through the controller(s) within the device.

In second mechanical configuration 1250 first and second flexural actuators 1250A and 1250B exploiting flexural actuators such as described supra in respect of FIG. 3A are employed. In contrast to preceding configurations depicted in respect of FIGS. 9 through 11 and first mechanical configuration 1250 the first and second flexural actuators 1250A and 1250B are orientated such that if the device comprising the second mechanical configuration 1250 was employed by a female then first flexural actuator 1250A would be vaginally inserted and engage their G-spot whilst the second flexural actuator 1250B would be anally inserted and engage the wall between lower side of the vaginal wall augmenting the sensations the user obtains from the first flexural actuator 1250A. As with preceding embodiments the first and second flexural actuators 1250A and 1250B may exploit in addition to pressure based stimulation additional elements to providing rubbing sensations and/or vibratory sensations according to the functionality provided and the control algorithm executed by the controller(s) within the device.

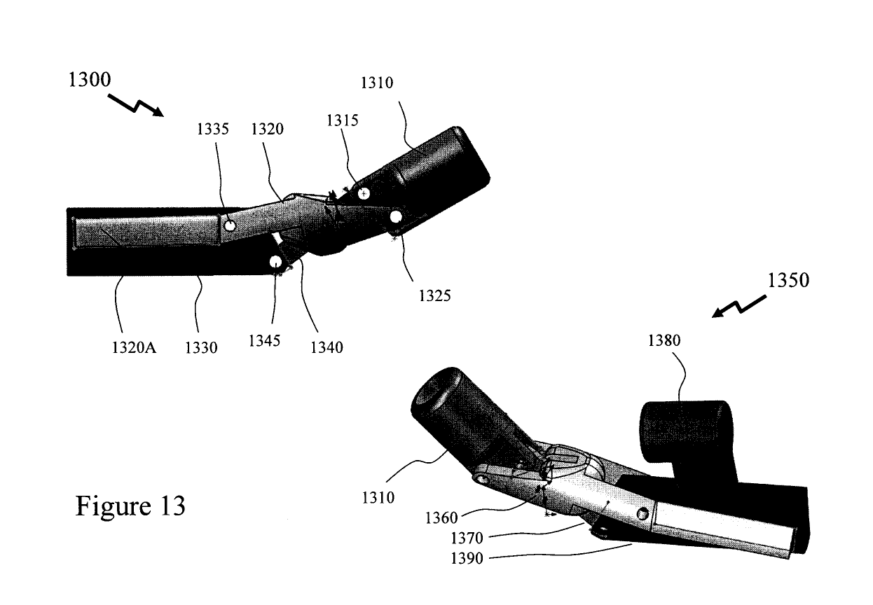

Now referring to FIG. 13 there are depicted first and second flexural actuators 1300 and 1350 respectively according to embodiments of the invention. As depicted first flexural actuator 1300 comprises body element 1330 to which is attached pivot element 1320 both directly via first pivot point 1335 and indirectly via second to fourth pivot points 1315, 1325 and 1345 through connections to link 1340 and housing 1310. Accordingly motion of arm 1320A of pivot element 1320 relative to the body element 1330 translates to motion of housing 1310. Arm 1320A being activated via a motor, not shown for clarity, such as described supra including, but not limited to, rotary motors, linear motors, and inchworm motors.

Second flexural actuator 1350 is essentially of similar design to first flexural actuator 1300 with body element 1390, pivot element 1360, link 1370, and housing 1310 except that a second housing 1380 is now attached to body element 1390. Second housing 1380 may for example be spring loaded such that as the portion of a device comprising second flexural actuator 1350 is inserted into an orifice of an individual such that housing 1310 is internally positioned the second housing 1380 is in contact with the exterior of their body under pressure from the spring as body element 1330 is maintained in position relative to the user's body. It would be evident that housing 1310 and second housing 1380 may form part of pressure providing elements or may be employed as mounting points for wiper actuators, such as described supra in respect of FIG. 4, vibratory elements, or mounting points for molded portions of the device for example. It would be evident that the material for a portion of a device engaging against the user may, in some embodiments of the invention, be a different material to that of the body of the device. For example, the body of the device may be a hard smooth plastic whereas the surfaces of an actuator against the user's body may be a softer silicone for example.

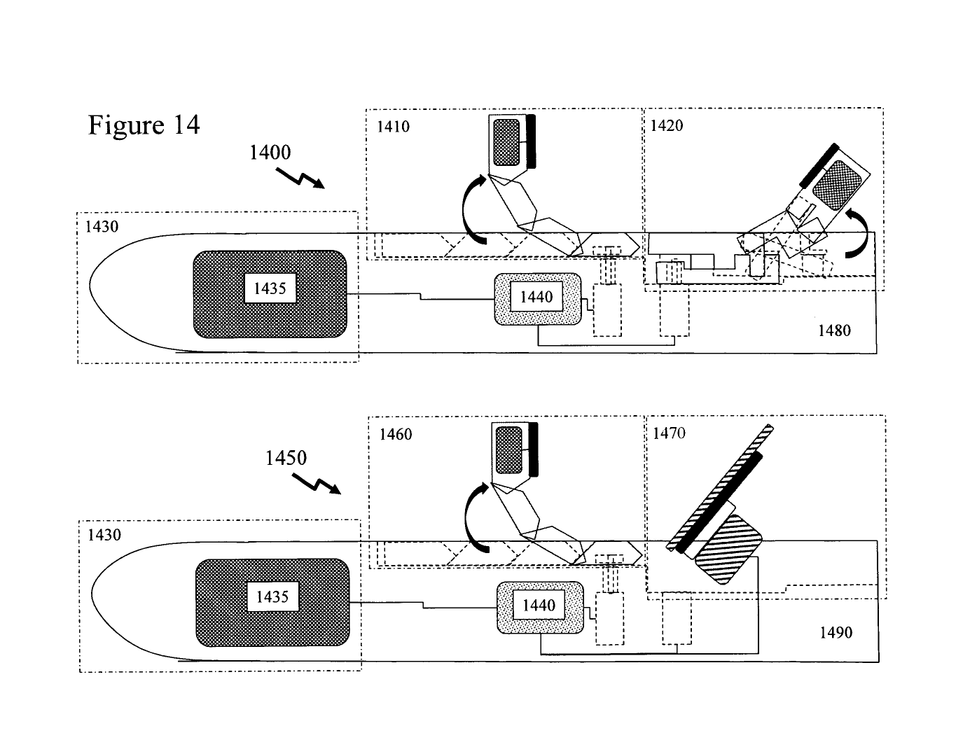

Referring to FIGS. 14A and 14B there are depicted first and second devices 1400 and 1450 with integral flexural actuators according to an embodiment of the invention. As depicted first device 1400 comprises a body 1480 disposed with a tip portion 1430 containing a vibrating element 1435, such as known in the art, connected to a controller 1440 thereby providing a vibratory stimulation to a user at the tip 1430. Also forming parts of first device 1400 are first and second flexural actuators 1410 and 1420 which are positioned to provide for example stimulation to a female user's G-spot and clitoris respectively. First and second actuators 1410 and 1420 respectively may be implemented according to embodiments of the invention described supra in respect of FIGS. 2A through 11 as well as others. As depicted first actuator 1410 exploits an actuator such as described in respect of FIG. 5 augmented with a vibratory element whereas second actuator 1420 exploits an actuator such as described in respect of FIG. 3 augmented with a vibratory element. Both the first and second actuators 1410 and 1420 being coupled, together with their vibratory elements, to the controller 1440.

Second device 1450 similarly comprises a body 1490 disposed with a tip portion 1430 containing a vibrating element 1435, such as known in the art, connected to a controller 1440 thereby providing a vibratory stimulation to a user at the tip 1430. Also forming parts of second device 1450 are flexural actuator 1460 and actuator 1470 which are positioned to provide for example stimulation to a female user's G-spot and clitoris respectively. Flexural actuator 1460 may be implemented according to embodiments of the invention described supra in respect of FIGS. 2A through 11 as well as others but as depicted flexural actuator 1460 exploits an actuator such as described in respect of FIG. 5 augmented with a vibratory element whereas actuator 1470 exploits an actuator such as described in respect of FIG. 4. Both the flexural actuator 1460 and actuator 1470 being coupled, together with ancillary elements such as vibratory element within flexural actuator 1450, to the controller 1440.

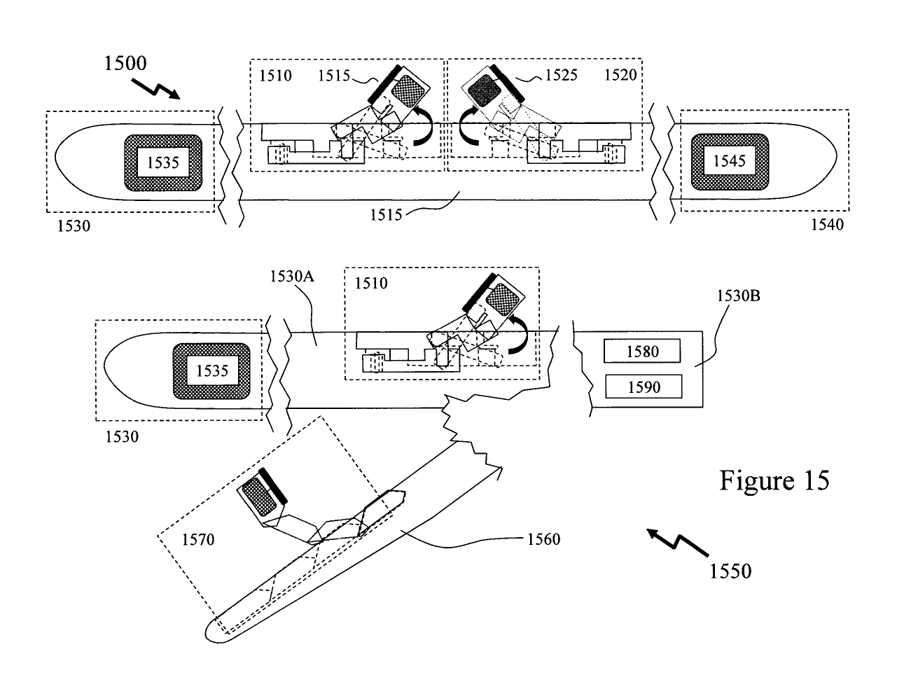

Now referring to FIG. 15 there are depicted first and second devices 1500 and 1550 with integral flexural actuators according to an embodiment of the invention. As depicted first device 1500 is a double end device with a main body 1515 with first and second tips 1530 and 1540 which are depicted with first and second vibratory elements 1535 and 1545 respectively. Disposed within main body 1515 are first and second flexural actuators 1510 and 1520, such as described supra in respect of FIG. 3 but implementable according to other embodiments of the invention including those depicted in FIGS. 2A through 11. First and second flexural actuators 1520 are orientated to transition from “open” to “closed” positions such that the ends 1515 and 1525 transition towards their respective device tips. Accordingly, wherein a device tip is vaginally inserted the respective actuator would engage upon the clitoris and accordingly first device 1500 allows for concurrent use by a pair of females. Other elements of first device 1500 including, but not limited to, battery and controller. In contrast second device 1550 is intended for single person use and comprises a main body 1530A with a flexural actuator 1510, such as flexural actuator 1510 in first device 1500 and as depicted in FIG. 3A but implementable according to other embodiments of the invention including those depicted in FIGS. 2A through 11. Disposed at the tip of main body 1530A is tip 1530 with vibratory element 1535 whilst disposed the other end are battery 1580 and controller 1590. Controller 1590 providing control signals to vibratory element 1535, flexural actuator 1510 as well as actuator 1570 which forms part of second body 1560 forming part of the second device 1550. Second device 1550 thereby providing pressure based stimulation, with or without augmentation through sliders, wipers, vibrators, etc., to a female user clitorally (flexural actuator 1510), vaginally (vibrator element 1535), and anally (actuator 1570) above and beyond the physical penetration of main body 1530A and second body 1560. Alternatively, second device 1550 may, if flexural actuator 1510 is reversed upon main body 1530A, provide stimulation to a male anally (flexural actuator 1510 and vibrator element 1535) with pressure applied to their testes or the region between their anus and testes via actuator 1570.

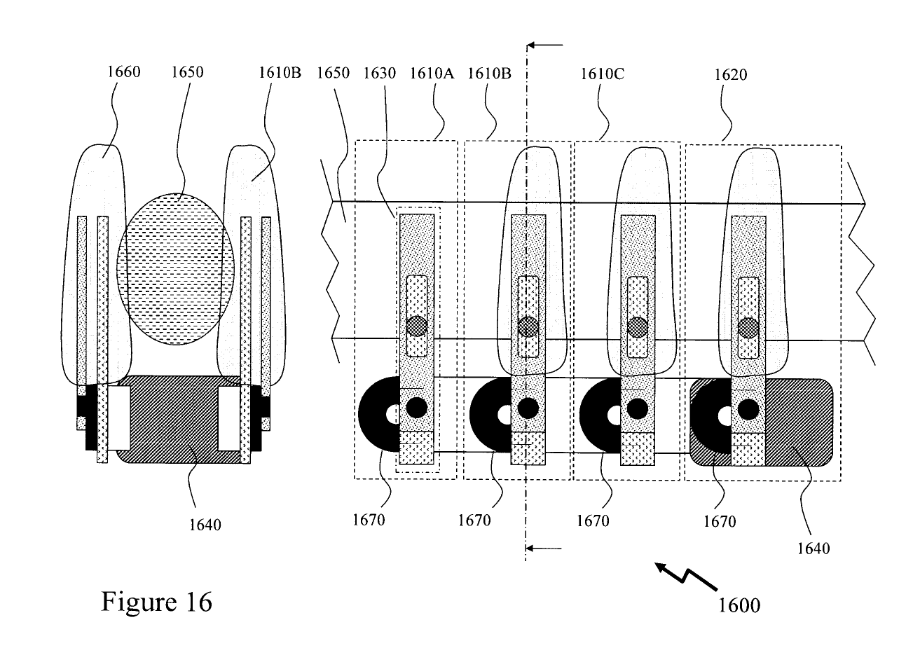

Now referring to FIG. 16 there is depicted a device 1600 with wiper motion according to an embodiment of the invention. As shown a plurality of first wiper actuators 1610A through 1610C together with second wiper actuator 1620 which includes motor 1640. Within each of first wiper actuators 1610A through 1610C and second wiper actuator 1620 are wiper structures 1630 which are driven through drive elements 1670 which are all linked to motor 1640. Wiper structures 1630 operating such as described supra in respect of FIGS. 4A and 4B to provide either wiper motion and/or wiper and slider motion. For example, a first subset of first wiper actuators 1610A through 1610C and second wiper actuator 1620 may provide just wiper motion whereas the remainder provide only slider motion or wiper and slider motion. As shown in cross-section below the first set of actuators, depicted by first wiper actuator 1610B, are a second set of actuators 1660 such that these would provide mechanical stimulation to either side of a body member 1650 such as a penis.

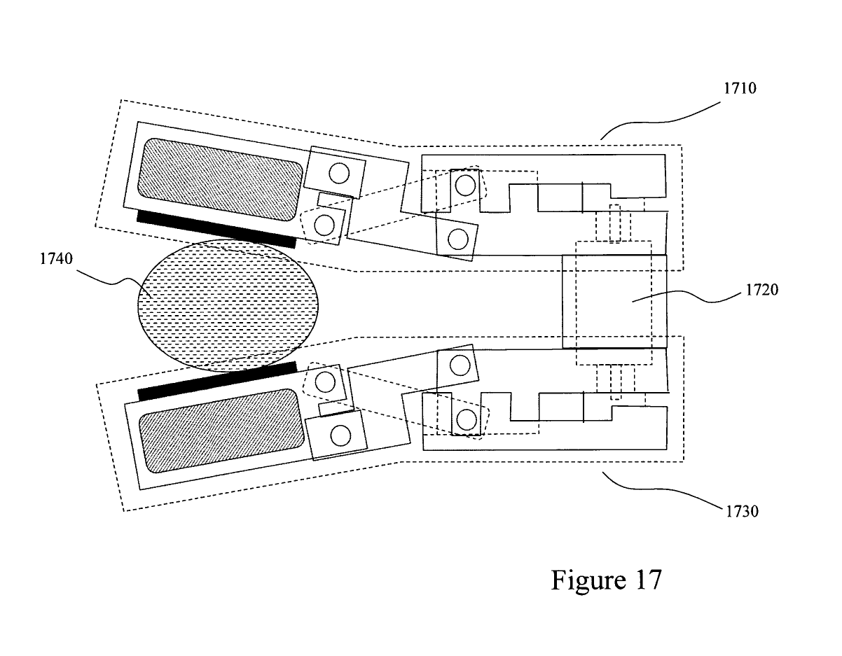

Referring to FIG. 17 there is depicted a device 1700 with first and second vibratory and flexural actuators 1710 and 1730 according to an embodiment of the invention. As shown first and second vibratory and flexural actuators 1710 and 1730 are mechanically coupled to body 1720 which comprises, for example, motor drivers for the actuators, controller, battery(ies), and user interface. First and second vibratory and flexural actuators 1710 and 1730 being depicted as flexural actuators such as described in respect of FIG. 3A with vibratory augmentation such as described in respect of flexural actuator 1000B in FIG. 10. Accordingly, first and second vibratory and flexural actuators 1710 and 1730 may under control of the controller within the device 1700 apply varying pressure to a portion of a user's body, for example a penis, clitoris, or nipple, as well as vibratory stimulation.

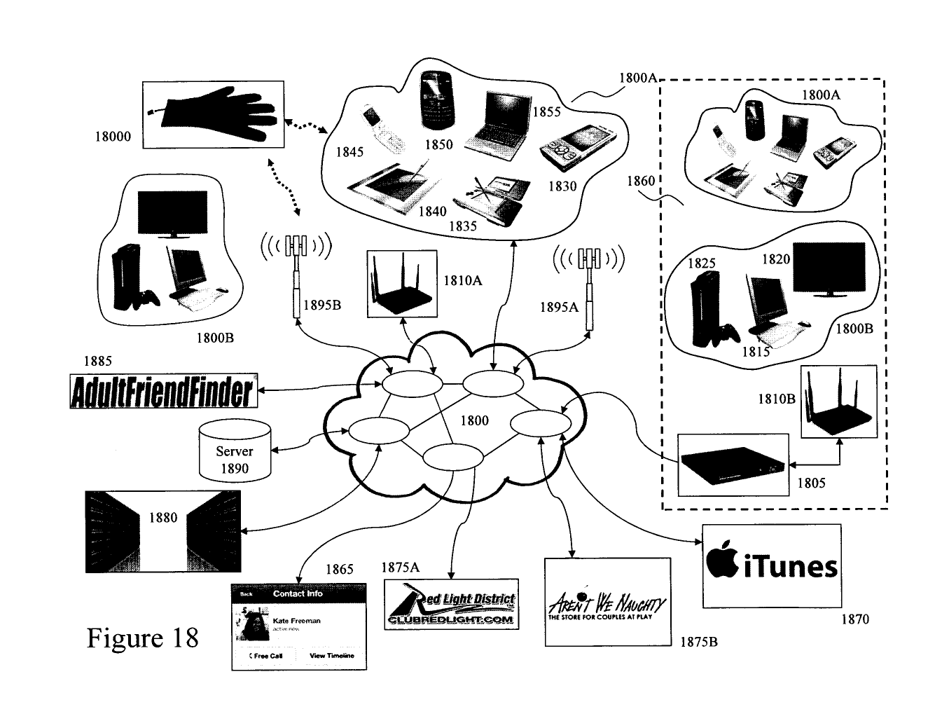

Referring to FIG. 18 there is depicted a network configuration supporting communications with a device according to an embodiment of the invention wherein first and second user groups 1800A and 1800B respectively interface to a telecommunications network 1800. Within the representative telecommunication architecture a remote central exchange 1880 communicates with the remainder of a telecommunication service providers network via the network 1800 which may include for example long-haul OC-48/OC-192 backbone elements, an OC-48 wide area network (WAN), a Passive Optical Network, and a Wireless Link. The central exchange 1880 is connected via the network 1800 to local, regional, and international exchanges (not shown for clarity) and therein through network 1800 to first and second cellular APs 1895A and 1895B respectively which provide Wi-Fi cells for first and second user groups 1800A and 1800B respectively. Also connected to the network 1800 are first and second Wi-Fi nodes 1810A and 1810B, the latter of which being coupled to network 1800 via router 1805. Second Wi-Fi node 1810B is associated with office building 1860 within which are other first and second user groups 1800A and 1800B. Second user group 1800B may also be connected to the network 1800 via wired interfaces including, but not limited to, DSL, Dial-Up, DOCSIS, Ethernet, G.hn, ISDN, MoCA, PON, and Power line communication (PLC) which may or may not be routed through a router such as router 1805.

Within the cell associated with first AP 1810A the first group of users 1800A may employ a variety of portable electronic devices including for example, laptop computer 1855, portable gaming console 1835, tablet computer 1840, smartphone 1850, cellular telephone 1845 as well as portable multimedia player 1830. Within the cell associated with second AP 1810B are the second group of users 1800B which may employ a variety of fixed electronic devices including for example gaming console 1825, personal computer 1815 and wireless/Internet enabled television 1820 as well as cable modem 1805. First and second APs 1895A and 1895B respectively provide, for example, cellular GSM (Global System for Mobile Communications) telephony services as well as 3G and 4G evolved services with enhanced data transport support. Second cellular AP 1895B provides coverage in the exemplary embodiment to first and second user groups 1800A and 1800B. Alternatively the first and second user groups 1800A and 1800B may be geographically disparate and access the network 1800 through multiple APs, not shown for clarity, distributed geographically by the network operator or operators. First cellular AP 1895A as show provides coverage to first user group 1800A and environment 1870, which comprises second user group 1800B as well as first user group 1800A. Accordingly, the first and second user groups 1800A and 1800B may according to their particular communications interfaces communicate to the network 1800 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 1800A may form associations either through standards such as IEEE 802.15 and Bluetooth as well in an ad-hoc manner.

Accordingly, a user of the first and second user groups 1800A and 1800B respectively may employ a device according to an embodiment of the invention including, but not limited to, those exploiting embodiments of the invention as described and depicted in FIGS. 12 and 14-17 or exploiting actuators discretely or in combinations such as described and depicted in FIGS. 2A through 11. Where the device has been provided with a wireless interface, such as for example a PAN, e.g. IEEE 802.15 or Bluetooth, a wireless interface, e.g. IEEE 802.11 WiFi or IEEE 802.16 WiMAX, or a Near Field Communications (NFC) interface then it may directly or indirectly access the Internet and accordingly one or more databases and/or services via the network 1800. Such databases and/or services being stored upon one or more servers, including server 1890, and related to data and or services from service providers including, but not limited to, multimedia content provider 1870, social media service 1865, adult content provider 1875A, adult product provider 1875B, and adult dating service 1885. These service providers with their servers and server 1890 may host according to embodiments of the inventions multiple services including, but not limited to, those associated with multimedia content, audio content, visual content, user profiles, device profiles, license databases, customer databases, websites, and software applications for download. Server 1890, and others not shown for clarity, may also host for example other Internet services such as a search engine, financial services, third party applications and other Internet based services.

Accordingly, a user with a device may for example access server 1890 to download new control algorithm(s) and/or control data for the device from the manufacturer for example or adult product provider 1875B. Adult product provider 1875B may therefore provide control algorithms and/or control data In other embodiments of the invention the user may access an item of multimedia content from multimedia content provider 1870 which is played upon a FED or PED but the audio track of the item of multimedia content is coupled to the controller of the device and triggers adjustments in the device such as for example adjusting the rate of a flexural actuator and/or wiper element or the audio content is coupled to the vibrator element. Alternatively, the user may access content from adult content provider 1875A wherein in addition to the downloaded content a configuration file for the device is provided wherein the characteristics of the device vary according to the particular portion of the downloaded content the viewer is currently watching. It would also be evident that the configuration file associated with the content may be varied based upon the device of the user or may contain contingent data allowing the same configuration file to be employed with multiple devices such that for example a double ended device such as described supra in respect of first device 1500 in FIG. 15 behaves differently to second device 1450 in FIG. 14.

If the user accesses social media service 1865 then they may access profiles of one or more friends, contacts, user groups, and adult communities within the social media service 1865 and thereby access device data files posted to the social media service 1865 by one or more social media members who are within the users friends, contacts, user groups, or adult communities. Such user data files may be accessed from the device via an application on the user's PED and/or FED which communicates to the device and triggers the transfer of the device data file(s). For example a user, Sarah, may post “Hey Girls, try this . . . I found it works wonders after a long day in the office” to her friends. Similarly, a user registering with adult dating service 1885 may access device data files provided on the adult dating service 1885 by another user or may access this other user's device data file based upon establishing a webcam link with them. Alternatively, the other user may elect to provide access during a communications session, such as webcam link, rather than making it generally accessible. In this manner the device may be configured, re-configured, or support multiple configurations based upon not only data associated with the controller at the time of purchase but accessed and stored temporarily/permanently by the user. Optionally, another service provider may for example be associated with a medical condition, medical community wherein device data files relate to adjustments of the device characteristics reflective of a medical condition for example.

Also depicted within the network configuration supporting communications with a device according to an embodiment of the invention of FIG. 18 is active glove 18000 which is depicted as being in wireless communication with either first group of users 1800A or second cellular AP 1895B, as depicted by dashed links. Embedded within active glove 18000 are sensors, not depicted for clarity, relating to finger motion and optionally pressure. Accordingly, the finger motion of a first user wearing active glove 18000 may be communicated through the network 1800 to a second user's device, the second user for example being a member of first user group 1800A or second user group 1800B. Alternatively, active glove 1800 may be connected to the second user's device directly through a PAN connection, e.g. Bluetooth, or through the first user's PED for example to the second user's device directly or through their PED for example. In these latter scenarios the first and second users may be in close proximity or may even be the same individual whilst in the former scenario with interconnection through network 1800 the first and second users have increased separation between them.

It would be evident that in other embodiments of the invention the actions of the first user with the active glove 1800 may control flexural/rubbing type actions on a device locally as well as remotely or that multiple remote devices might be controlled through the active glove 1800. Additionally, the motions of the user with active glove 1800 may be stored within either of the first and/or second user's devices/PEDs for example or within remote storage such as Server 1890 for example. Accordingly, motions/actions may be subsequently retrieved and employed in controlling one or more devices either as part of establishing device control routines such as by one or more of multimedia content provider 1870, social media service 1865, adult content provider 1875A, adult product provider 1875B, and adult dating service 1885. It would be evident that other methods of controlling the device exist other than glove based flexure sensors including, but not limited, data processing of video data, game controllers, gyroscopes, and tilt sensors.

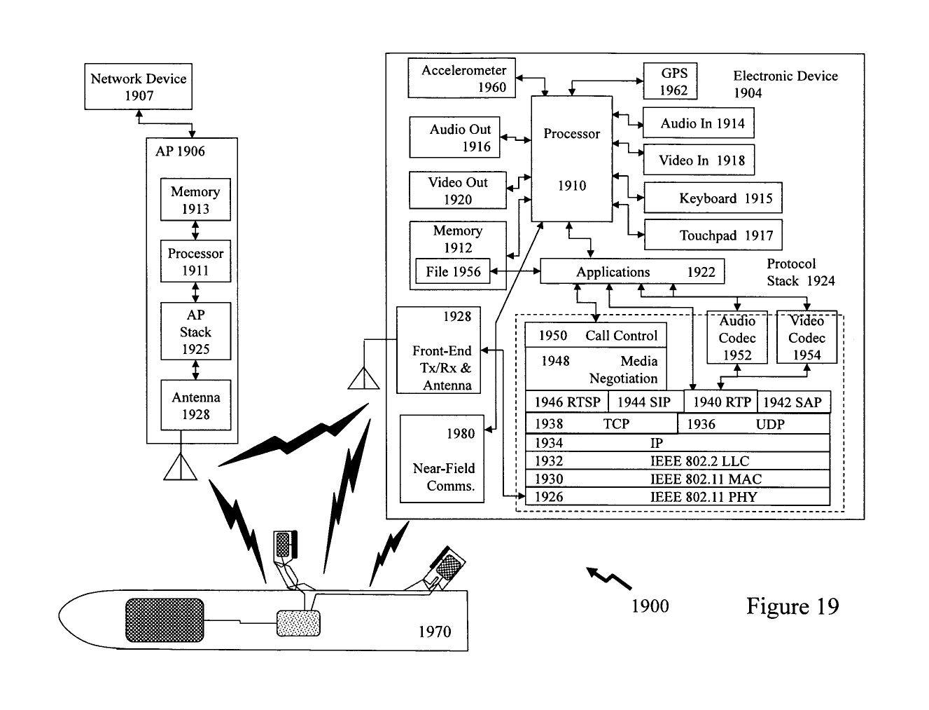

Now referring to FIG. 19 there is depicted a configuration supporting local communications between a Device 1970, a user's Electronic Device 1904, and a wireless access point 1907 according to an embodiment of the invention supporting device data configuration file transfer discretely or in association with additional content such as described above in respect of FIG. 18. Electronic Device 1904 may for example be a PED or FED and may include additional elements above and beyond those described and depicted. Also depicted within the Electronic Device 1904 is the protocol architecture as part of a simplified functional diagram of a system 1900 that includes an Electronic Device 1904, such as a smartphone 1855, an access point (AP) 1906, such as first AP 1810, and one or more network devices 1907, such as communication servers, streaming media servers, and routers for example such as first and second servers 690A and 690B respectively. Network devices 1907 may be coupled to AP 1906 via any combination of networks, wired, wireless and/or optical communication links such as discussed above in respect of FIG. 18. The Electronic Device 1904 includes one or more processors 1910 and a memory 1912 coupled to processor(s) 1910. AP 1906 also includes one or more processors 1911 and a memory 1913 coupled to processor(s) 1910. A non-exhaustive list of examples for any of processors 1910 and 1911 includes a central processing unit (CPU), a digital signal processor (DSP), a reduced instruction set computer (RISC), a complex instruction set computer (CISC) and the like. Furthermore, any of processors 1910 and 1911 may be part of application specific integrated circuits (ASICs) or may be a part of application specific standard products (ASSPs). A non-exhaustive list of examples for memories 1912 and 1913 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 1904 may include an audio input element 1914, for example a microphone, and an audio output element 1916, for example, a speaker, coupled to any of processors 1910. Electronic Device 1904 may include a video input element 1918, for example, a video camera, and a video output element 1920, for example an LCD display, coupled to any of processors 1910. Electronic Device 1904 also includes a keyboard 1915 and touchpad 1917 which may for example be a physical keyboard and touchpad allowing the user to enter content or select functions within one of more applications 1922. Alternatively the keyboard 1915 and touchpad 1917 may be predetermined regions of a touch sensitive element forming part of the display within the Electronic Device 1904. The one or more applications 1922 that are typically stored in memory 1912 and are executable by any combination of processors 1910. Electronic Device 1904 also includes accelerometer 1960 providing three-dimensional motion input to the process 1910 and GPS 1962 which provides geographical location information to processor 1910.

Electronic Device 1904 includes a protocol stack 1924 and AP 1906 includes a communication stack 1925. Within system 1900 protocol stack 1924 is shown as IEEE 802.11 protocol stack but alternatively may exploit other protocol stacks such as an Internet Engineering Task Force (IETF) multimedia protocol stack for example. Likewise AP stack 1925 exploits a protocol stack but is not expanded for clarity. Elements of protocol stack 1924 and AP stack 1925 may be implemented in any combination of software, firmware and/or hardware. Protocol stack 1924 includes an IEEE 802.11-compatible PHY module 1926 that is coupled to one or more Front-End Tx/Rx & Antenna 1928, an IEEE 802.11-compatible MAC module 1930 coupled to an IEEE 802.2-compatible LLC module 1932. Protocol stack 1924 includes a network layer IP module 1934, a transport layer User Datagram Protocol (UDP) module 1936 and a transport layer Transmission Control Protocol (TCP) module 1938.

Protocol stack 1924 also includes a session layer Real Time Transport Protocol (RTP) module 1940, a Session Announcement Protocol (SAP) module 1942, a Session Initiation Protocol (SIP) module 1944 and a Real Time Streaming Protocol (RTSP) module 1946. Protocol stack 1924 includes a presentation layer media negotiation module 1948, a call control module 1950, one or more audio codecs 1952 and one or more video codecs 1954. Applications 1922 may be able to create maintain and/or terminate communication sessions with any of devices 1907 by way of AP 1906. Typically, applications 1922 may activate any of the SAP, SIP, RTSP, media negotiation and call control modules for that purpose. Typically, information may propagate from the SAP, SIP, RTSP, media negotiation and call control modules to PHY module 1926 through TCP module 1938, IP module 1934, LLC module 1932 and MAC module 1930. Also depicted within Electronic Device 1904 is NFC Communications (Comms.) module 1980 supporting NFC communications according to an NFC standard for communications protocols and data exchange formats for example or based upon a proprietary format. Typically, NFC communications follow existing radio-frequency identification (RFID) standards including ISO/IEC 14443 and FeliCa but may also follow ISO/IEC 18092 and those defined by the NFC Forum. Accordingly, communications between Electronic Device 1904 and Device 1970 via NFC Comms. 1980 typically require the Electronic Device 1904 and Device 1970 to be approximately 10 cm (4 inches) apart rather than the much larger separations of 20-50 metres (approximately 70-180 feet) between devices exploiting IEEE 802.11 communications. As such NFC communications may be suitable for updating configurations or transferring data files but not generally dynamic configuration adjustments based upon streamed content for example.

It would be apparent to one skilled in the art that elements of the Electronic Device 1904 may also be implemented within the AP 1906 including but not limited to one or more elements of the protocol stack 1924, including for example an IEEE 802.11-compatible PHY module, an IEEE 802.11-compatible MAC module, and an IEEE 802.2-compatible LLC module 1932. The AP 1906 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Accordingly, Device 1970 may directly communicate with AP 1906 in some embodiments of the invention.

PEDs and FEDs represented by Electronic Device 1904 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC). In some embodiments of the invention the Device 1970 may support one or more wireless or wired interfaces according to the transceiver provided within the Device 1970 and whether the Device 1970 employs a wired power connection or is battery based.

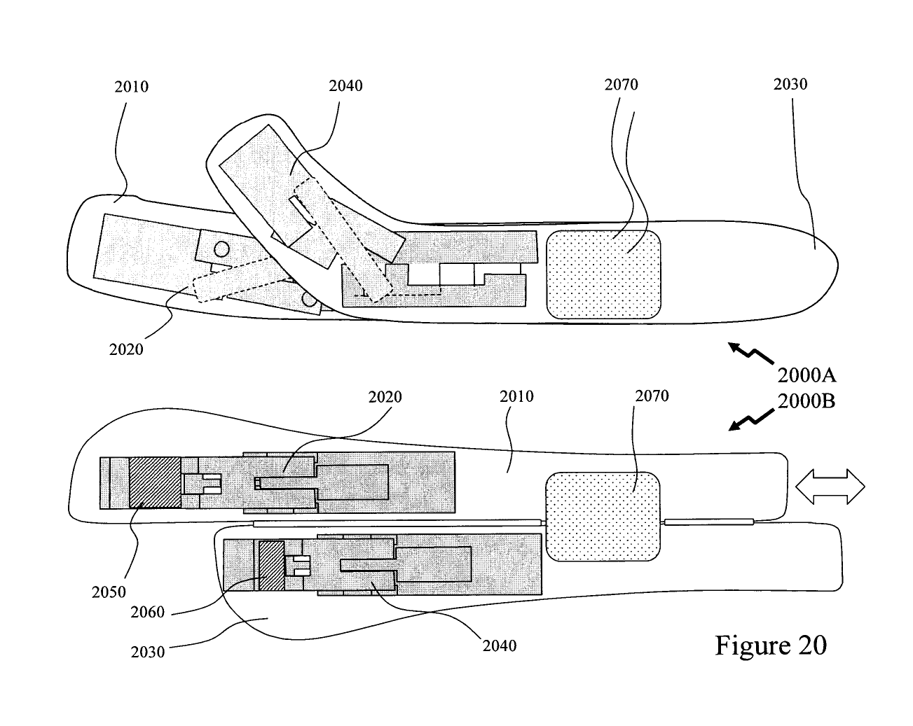

Now referring to FIG. 20 there is depicted in first and second views 2000A and 2000B a device employing first and second flexural actuators 2020 and 2040 respectively within a split sliding housing comprising first and second shells 2010 and 2030 respectively according to an embodiment of the invention. As shown in second view 2000B representing a plan view of the device first flexural actuator 2020 is within the bulbous end of the first shell 2010 and the second flexural actuator 2040 is within the bulbous end of the second shell 2030. The first and second shells 2010 and 2030 slide relative to one another under the action of actuator 2070. Then as depicted in first view 2000A representing a side view of the device then it can be seen that the first and second flexural actuators 2010 and 2030 can flex out of the plane of the device whilst they are sliding relative to one another. In this manner the first and second shells 2010 and 2030 may apply varying pressure and motion against the skin of a user. Under the action of a controller, not shown for clarity, the motion of the upper surface portion of either first and second shell 2010 or 2030 respectively may therefore be programmed as following, for example, the inner upper vaginal wall of a user such that as a shell moves deeper it also actuates more. As discussed supra an initial control routine of the device may be modified by the user.

It would be evident that optionally first and second shells 2010 and 2030 may be retained within a shaft which the user holds such that what they hold does not slide within their hand and contains in a handheld isolated device the batteries and controller. Optionally, the motion of the shells relative to one another when mounted within such a shaft may be independent such that one or both may be sliding and/or flexing whilst the other is flexing or applying constant pressure. Other control scenarios may be considered as well as the provisioning of a vibrating element within one or both shells such that the flexural actuator may be in contact and vibrating or moving and vibrating for example.

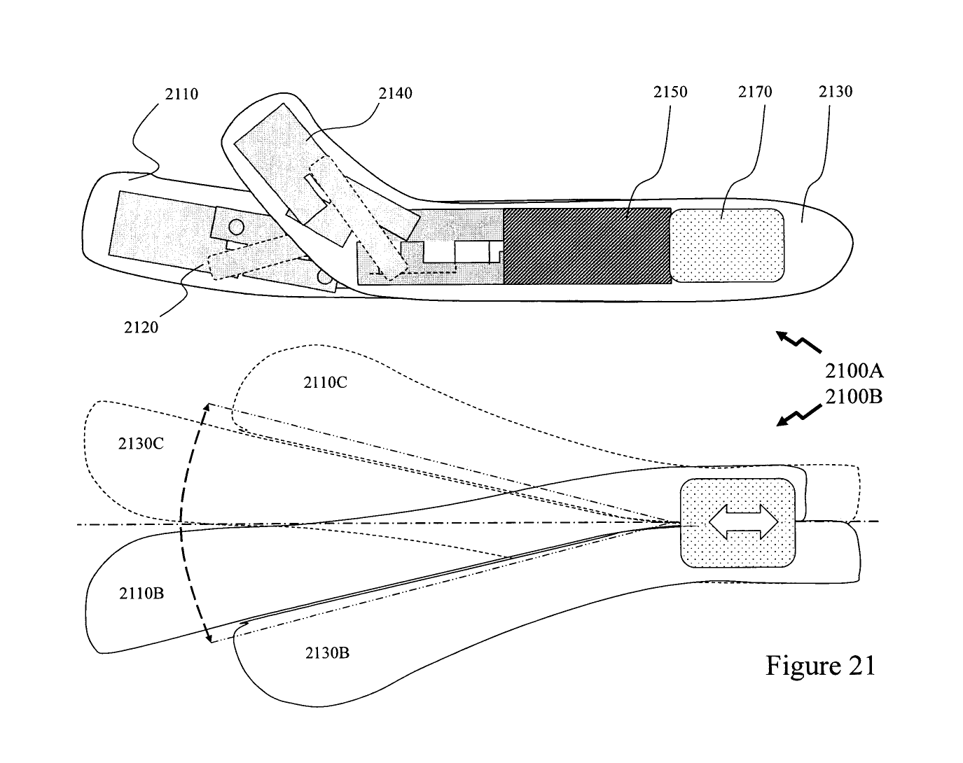

In FIG. 21 there is depicted in side and plan views 2100A and 2100B respectively for a device employing first and second flexural actuators 2120 and 2140 respectively within a split sliding housing comprising first and second shells 2110 and 2130 respectively according to an embodiment of the invention and as such has a very similar construction to that of the device described supra in respect of FIG. 20. However, now the first and second flexural actuators 2120 and 2140 respectively also each respectively comprise a secondary flexural actuator 2150. Accordingly, as depicted in plan view 2100B the resulting motion of the first and second shells 2110 and 2130 respectively now includes in addition to forward/back motion generated by the actuator 2170 and the bending motion from the first and second flexural actuators 2120 and 2140 respectively a lateral bending from action of the secondary flexural actuators 2150 such that the first and second shells 2110 and 2130 bend laterally from aligned axial position in one direction to first locations 2110B and 2130B to second locations 2110C and 2130C. Accordingly more complex motions can be generated with insertion/removal, pressure application/removal, and lateral motion.

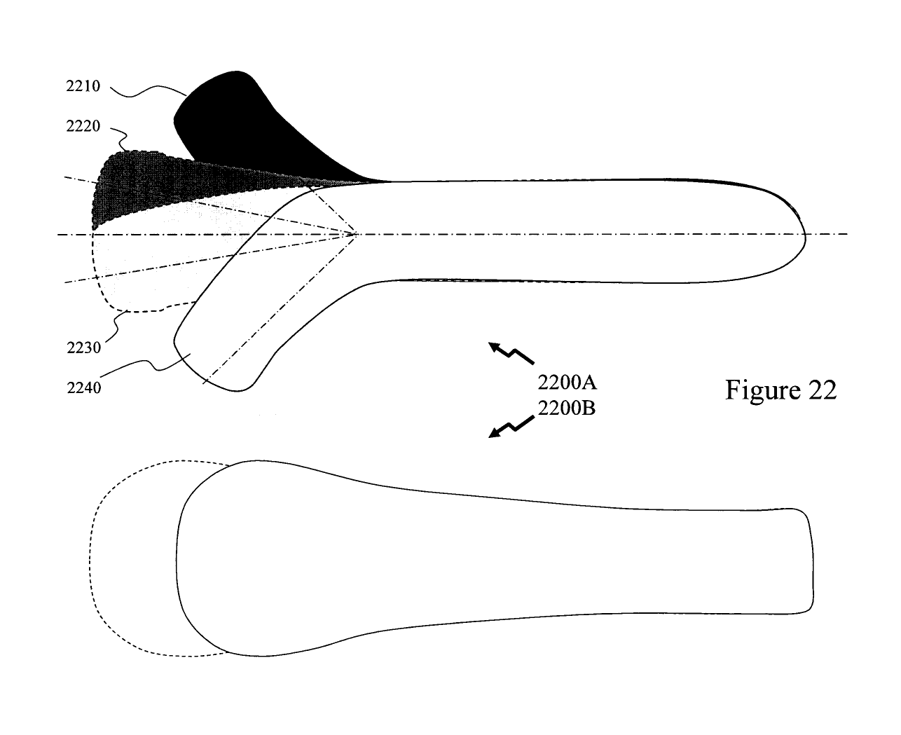

Now referring to FIG. 22 there is depicted a device exploiting flexural actuators according to an embodiment of the invention in side and plan views 2200A and 2200B respectively. In this instance the device exhibits motion at its tip in one direction such that it transitions from one vertical limit 2210 to another vertical limit 2240 in the other direction although the limits may be adjusted by the user such as those depicted by upper and lower limits 2220 and 2230 respectively. As depicted in plan view 2200B the bulbous end of the device is such that the pressure applied from the motion of the device against the user is over a larger area. Optionally, the bulbous end of the device may be textured through molding to simulate a number of fingers or may in fact be split but semi-rigidly attached together to simulate a number of separated fingers. Similarly, other elements may be included into the “active” ends of the devices depicted supra in respect of embodiments of the invention such that in addition to flexural motion/pressure the user may feel addition sensations such as heat, cold, vibration, smooth surfaces, and rough surfaces as well as the controllers supporting a range of amplitudes, frequencies etc. with or without user configuration/personalization.

It would be evident that devices according to embodiments of the invention described and depicted with respect to FIGS. 2A through 22 may be offered to consumers with a range of physical geometries, lengths, diameters, and/or angular motion ranges. For example, device with a configuration such as depicted in FIG. 3B may be offered with a limited angular motion range as wide motion range may be left to the user through manual manipulation or offered with a large range of motion as depicted.

Within the embodiments of the invention described above in respect of FIGS. 2A through 11 actuators have been described providing pressure stimulation through moving actuators as well as vibration actuators. Optionally, one or more pressure sensors may be integrated to the actuator(s) allowing real-time monitoring of the pressure applied to be fed back to the controller either to provide verification of actuator response, to de-activate an actuator where no pressure is determined, or de-activate/adjust an actuator if a predetermined threshold is exceeded. In some embodiments of the invention this predetermined threshold may be set by the device manufacturer or adjusted during a calibration/set-up routine by the user as individuals have different pain/stimulation thresholds. Further, within these embodiments the interface between the user and the controller has not been described in respect to starting the device, stopping the device, and adjusting the performance of the device, where the device incorporates embodiments of the invention. These user interfaces may be provided on the device itself, as known in the prior art, as well as a user's PED and/or FED through an application provided with the purchase of the device or subsequently acquired.

In terms of materials for the fabrication of the device a variety of materials may be employed in conjunction with the flexural actuators including for example closed-cell foam, open-celled foam, polystyrene, expanded polystyrene, extruded polystyrene foam, polyurethane foam, phenolic foams, rubber, latex, jelly-rubber, silicone rubber, elastomers, stainless steel, Cyberskin and glass. Examples of manufacturing processes include, but are not limited to, dip-coating, thermoforming and injection molding. Devices may be completely self-contained within the body without electrical connections wherein recharging of the batteries within the device is achieved through inductive coupling. In some embodiments of the invention the finished surface of the device may be smooth whilst in others it may have a texture, e.g. to simulate skin, or be rough for increased friction against the user's skin. Similarly, the devices according to embodiments of the invention may be provided in a variety of colours and include other features known within the prior art such as vibrators, heaters, nubbed regions, and rotating beads for example.

Within embodiments of the invention described above communication of control data to the device has been primarily described with respect to wireless based formats. Alternatively, such control data may be provided through other means including, but not limited to, visible, infrared, and ultrasonic.

Within embodiments of the invention with respect to devices and the electronic control the descriptions supra in respect of the Figures have in some instances described electrical power as being derived from batteries, either standard replaceable designs such as alkaline or rechargeable. In other embodiments where electrical power was not explicitly described it would be evident to one skilled in the art that this would be provided. Accordingly, such devices would be self-contained with electrical power source, controller, and actuator(s) all formed within the same body. It would be evident that the flexural actuator(s) and electronic controller are preferably low power, high efficiency designs when considering battery driven operation although electrical main connections may ease such design limits or those with external battery modules. However, alternate embodiments of devices may be configured in so-called wand type constructions, see for example Hitachi Magic Wand within the prior art for example, wherein increased dimensions are typical but additionally the device includes a power cord and is powered directly from the electrical mains via a transformer. Optionally, a device may be configured with battery and electrical mains connections via a small electrical connector with a cord to a remote transformer and therein a power plug. In this format increased power or functionality may be provided/offered with the device on mains power versus that when isolated and operating from battery power.

Within embodiments of the invention described supra particular activation mechanisms in respect of the flexural actuators have been described. However, it would be evident to one skilled in the art that other combinations of mechanical actuation may be employed either discretely or in combination to provide the specific biomimic functions and other functions described within this specification. Accordingly, the flexural actuators exploit an electric actuator, which converts electrical energy into mechanical torque, and a mechanical actuator, which typically convert rotary motion into linear motion or vice-versa. Such actuations may exploit one or more actions including, but not limited to, those based upon pulleys, rails, wires, chains, gears, belts, rotary motors, roller screw drives, ball screw drives, inch-worm drives, linear motors, piezomechanical materials, piezeoelectric materials, elastic materials, shape memory alloys, electroactive polymers, artificial muscle etc. It would therefore be evident to one skilled in the art that the same flexural and/or rotary motions provided by the actuators described above in respect of FIGS. 2A to 22 respectively may be implemented using a range of combinations of electric and mechanical actuators according to design requirements of the device and/or actuator. Such requirements may include, but are not limited to, pressure range, motion range, motion frequency/speed, power requirements, duration of power source, and motion required.

Whilst the embodiments of the invention have been described above in respect of human fingers and thumbs it would be evident that alternatively flexural actuators according to embodiments of the invention may simulate other human digits e.g. toes, as well as digits of other animals.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1-23. (canceled)

24. A sexual stimulation device for stimulating a user comprising at least a flexural actuator which mimics at least one of a human finger and a human thumb.

25. The sexual stimulation device according to claim 24, wherein the sexual stimulation device comprises an electrically controlled motor comprising at least a shaft and at least a flexural actuator converting motion of the shaft of the motor to flexure of a predetermined portion of the flexural actuator.

26. The sexual stimulation device according to claim 24, further comprising a lateral actuator comprising a wiper actuator for converting motion of a shaft of a motor to a predetermined locus of motion of a predetermined portion of the wiper actuator to simulate at least one of lateral and circular motion of the at least one of a human finger and a human thumb.

27. The sexual stimulation device according to claim 24, further comprising a motor that provides for rotary motion of a shaft such that a predetermined number of turns of the shaft result in the flexural actuator flexing from a first predetermined position to a second predetermined position and back again to the first predetermined position.

28. The sexual stimulation device according to claim 24, further comprising a vibratory actuator mechanically mounted to a tip portion of the flexural actuator, the tip portion of the flexural actuator being distal to the motor.

29. The sexual stimulation device according to claim 24, further comprising;
a second flexural actuator converting motion of a shaft of a motor to flexure of a predetermined portion of the second flexural actuator, wherein
the motion of the flexural actuator and the second flexural actuator whilst each mimicking at least one of a human finger and a human thumb execute combined motions that cannot be achieved with the human hand.

30. The sexual stimulation device according to claim 24, wherein the sexual stimulation device forms a predetermined portion of another sexual stimulation device for use in sexually stimulating a user of the another sexual stimulation device.

31. A sexual stimulation device comprising;
a first motor comprising at least a first shaft;
a second motor comprising at least a second shaft;
a wiper actuator coupled to the first shaft converting motion of the first shaft to a predetermined locus of motion of a predetermined portion of the wiper actuator;
a flexural actuator to which the wiper actuator is mechanically connected, the flexural actuator also coupled to the second shaft converting motion of the second shaft to a flexing of the flexural actuator; wherein
the resulting motions of the wiper actuator and flexural actuator under control of a controller result in executed motions of the predetermined portion of the wiper actuator which cannot be made by a human finger.

32. The sexual stimulation device according to claim 31 wherein,
the wiper actuator is mechanically mounted to a tip portion of the flexural actuator, the tip portion of the flexural actuator being distal to the second motor.

33. The sexual stimulation device according to claim 31 wherein,
the wiper actuator at least one of has the flexural actuator mounted to it and forms part of the flexural actuator.

34. The sexual stimulation device according to claim 31 further comprising;
a vibratory actuator mechanically mounted to a tip portion of the flexural actuator, the tip portion of the flexural actuator being distal to the second motor.

35. The sexual stimulation device according to claim 31 wherein,
the second motor provides for rotary motion of the second shaft such that a predetermined number of turns of the second shaft result in the flexural actuator flexing from a first predetermined position to a second predetermined position and back again to the first predetermined position.

36. The sexual stimulation device according to claim 31 wherein,
the first motor provides for rotary motion of the first shaft such that a predetermined number of turns of the first shaft result in the wiper actuator executing a wiping type action from a first predetermined position to a second predetermined position and back again to the first predetermined position.

37. The sexual stimulation device according to claim 31, wherein
the sexual stimulation device forms a predetermined portion of another sexual stimulation device for use in sexually stimulating a user of the another sexual stimulation device.

38. A sexual stimulation device comprising;
a controller coupled to a motor;
a flexural actuator for converting motion of the motor to flexure of the flexural actuator; and
a receiver operating according to a predetermined standard coupled to the controller for receiving control data from a transmitter for execution by the controller in controlling the motor.

39. The sexual stimulation device according to claim 38 further comprising;
a second motor;
a wiper actuator coupled to the second motor, the controller, and the flexural actuator, the wiper actuator for converting motion of the second motor to a predetermined locus of motion of a predetermined portion of the wiper actuator; wherein
the resulting motions of the wiper actuator and flexural actuator under control of the controller result in executed motions of the predetermined portion of the wiper actuator which cannot be made by a human finger.

40. The sexual stimulation device according to claim 38 further comprising;
a second flexural actuator mounted in a first predetermined position on a body of the sexual stimulation device to which the flexural actuator is also mounted in a second predetermined position, the second flexural actuator for converting motion of a second motor to flexure of the second flexural actuator.

41. The sexual stimulation device according to claim 38 wherein,
the first and second flexural actuators are positioned such that the first flexural actuator may apply pressure to a woman's G-spot whilst the second flexural actuator may apply pressure to the woman's clitoris.

42. The sexual stimulation device according to claim 38 further comprising;
a wiper actuator coupled to a second motor, the controller, and the flexural actuator, the wiper actuator for converting motion of the second motor to a predetermined locus of motion of a predetermined portion of the wiper actuator; wherein
the wiper actuator is mounted in a first predetermined position on a body of the sexual stimulation device to which the flexural actuator is also mounted in a second predetermined position.

43. The sexual stimulation device according to claim 42 wherein,
the wiper and flexural actuators are positioned such that the flexural actuator may apply pressure to a woman's G-spot whilst the wiper actuator may apply a rubbing motion to the woman's clitoris.
